(19) United States
(12) Patent Application Publication
(10) Pub. No.: US 2019/0293443 A1
(43) Pub. Date: Sep. 26, 2019

(54) VEHICLE ROUTE GUIDANCE

(71) Applicant: INVENTIVE COGS (CAMPBELL) LIMITED, Derby (GB)

(72) Inventors: James Alexander KELLY, Redditch (GB); Martyn LATHBURY, Measham (GB); Edoardo BACCI, Birmingham (GB); David PARKER, Coventry (GB); Nicholas Andrew HAWES, Kidlington (GB)

(21) Appl. No.: 16/348,724

(22) PCT Filed: Nov. 9, 2017
(86) PCT No.: PCT/GB2017/053377

§ 371 Date: May 9, 2019

(30) Foreign Application Priority Data
Nov. 9, 2016 (GB) 1618878.1
Nov. 9, 2016 (GB) 1618881.5
Nov. 9, 2016 (GB) 1618884.9

(51) Int. Cl. G01C 21/34; G08G 1/0968

(52) U.S. Cl. CPC G01C 21/3492; G01C 21/3469; G08G 1/096844; G01C 21/3415; G08G 1/096827; G01C 21/3446

(57) ABSTRACT

An electronic device for determining a journey guidance policy for use in guidance on a journey from a first location to a second location. The electronic device is configured to obtain an end objective indicative of an objective to be achieved at the end of the journey at the second location. A plurality of probabilistic states for the journey are determined, where, each probabilistic state comprises: a state location, indicative of a geographical location; and a progress metric. Based at least in part on the plurality of probabilistic states and the end objective, the journey guidance policy is determined. The journey guidance policy comprises the plurality of probabilistic states and a recommended action corresponding to each of the plurality of probabilistic states, where each recommended action comprises a speed action and a navigation action.

### BACKGROUND

Navigation systems, sometimes referred to as satellite navigation systems, or ‘satnav’ systems, are widely used by vehicle drivers to help guide them to their desired destination. Example navigation systems include dedicated navigation modules, such as those offered by TomTom®, and software modules or applications that may be operated on generic mobile electronic devices, such as smartphones or tablet computers. Typically, the navigation system will identify its current location (and therefore the current location of the operators vehicle), using a location system such as the Global Positioning System (GPS), and receive an indication from the operator of their desired destination (for example, a postcode, or ZIP code, or a street address, or landmark name, etc). The navigation system then determines a route from the current location to the desired destination and instructs the vehicle driver how to navigate that route with audio and/or visual guidance. During the journey, the navigation system uses the location system to track its current location so that guidance can be given to the driver at any decision points (for example, road junctions) to help keep the vehicle on the determined route. If the driver accidentally strays from the route, guidance can also be given either to navigate them back onto the determined route, or to determine a new route.

Route determination typically considers the start location (usually the current location, identified using the location system), the desired destination, the road network (also sometimes known as the street network), i.e., the layout of the roads or streets, as represented on a map, and the current traffic conditions on the road network. A tree traversal (for example, as described here: https://en.wikipedia.org/wiki/Tree_traversal) is used, having one or more heuristic functions that identify potential routes and rank them by how quickly they are expected to get the driver to the desired destination, based on the road network and the current traffic conditions. The operator of the navigation system may be offered a number of potential routes (for example, three), with an expected destination arrival time associated with each potential route, with the operator choosing the route that they would like to use for the journey. Route searching algorithms of this type are implemented in navigation systems such as Google® Maps, TomTom® and Bing® Maps. Heuristic functions, also called heuristics, are described here: https://en.wikipedia.org/wiki/Heuristic_(computer_science) and their use in existing route searching algorithms will be well understood by the skilled person.

In some examples, part way through the journey, the navigation system may calculate a new route and offer it to the operator. For example, this may happen if the information on which the original route was determined has significantly changed (for example, traffic conditions have become considerably worse) and/or if a new route would offer a significant time benefit (for example, five minutes or more may be saved by taking a new route). However, the driver will be directed to follow the original route until such time during the journey that a newly calculated route may offer a significant enough benefit to warrant a change of route mid-way through the journey. Consequently, marginal gains and benefits may be missed and significant gains and benefits may only be realised by a whole new route being determined.

As well as private use (for example, an individual wishing to drive their car or automobile to a particular destination), navigation systems are also used for commercial purposes. For example, they can be used for logistics and/or delivery services. In one example, they may be used to optimise a sequence of deliveries for a particular delivery vehicle (for example, a van or truck), and then help to guide the driver of the delivery vehicle on a route that executes the optimised sequence of deliveries. An example of such as system is Google® Map Transportation. In another example, the allocation of deliveries to particular vehicles in a fleet of vehicle may be optimised alongside the optimisation of the sequence of the deliveries allocated to each vehicle. An example of such a system is implemented by Route Monkey®.

A number of navigation systems offer an application programming interface (API) for use by third parties to display additional information/offer specialised services. One example of the use of navigation APIs is that of electric vehicle (EV) range advisors, such as EV Trip Planner (http://evtripplanner.com/). They may typically utilise a navigation API to obtain a route plan from a navigation system, and then additionally consider in what type of vehicle the operator will be making the journey (for example, the make and model of the vehicle), the current average speed of road users on the road network, how the operator typically drives relative to the average speed of road users on the road network, and what the topography of the network is. Guidance can then be given about expected energy use to make the journey and whether or not the vehicle is likely to complete the journey on a single charge.

With all of these navigation systems a single route is set prior to commencement of the journey. The driver may then embark on that set single route. The route is determined based upon what appears to be the optimum route considering the traffic conditions at the moment of route determination or on predicted traffic conditions based on historical data. If the actual traffic conditions subsequently change during the journey, the driver is likely to arrive at a different time to that indicated when selecting the route, which may cause significant inconvenience or annoyance for the driver. Whilst an estimated time of arrival may be regularly communicated to the driver (for example, by displaying it to the driver on a screen along with any directional guidance that is given) as they progress along the route, either faster or slower than was expected during the route determination process, it is incumbent on the driver to monitor how the time changes and attempt to alter their driving (if possible) as necessary in order to keep to their intended schedule. This constant monitoring and determination of any changes to driving style (such as increasing or decreasing speed) may be a significant burden on the driver. If the traffic conditions change by a significant amount meaning that the driver is likely to arrive at the destination considerably later than expected, the navigation system may recalculate an optimum route and offer that to the driver. However, because re-routing only takes place when the driver has fallen a long way behind schedule, they are still likely to arrive significantly later than they had expected.

Consequently, it can be seen that the navigation systems described above offers a relatively inflexible solution to route planning and guidance. Drivers receive little support in efforts to arrive at a destination at a particular time, particularly during the journey, and may often find themselves arriving at a different time to their expected time of arrival, due to a lack of proactive assistance from the navigation system.

A number of vehicles today are capable of offering the driver assistance, guidance and support in their driving. The Society of Automotive Engineers has defined levels of driving automation in the International Standard J3016. At level [SAE0], no automation of the vehicle is provided. Internal Combustion Engine (ICE) revolution guidance may be provided, such as a display that indicates an optimal band of revolutions that the driver should aim to keep the engine within in order to maximise efficiency (for example, the Volvo® Truck system described here: http://www.volvotrucks.com/dealers-vtc/en-gb/VTBC-London/promotions/toptips/Pages/economicaldrivingtips.aspx). However, this system relies upon) the driver taking note of the guidance and making the effort to both attempt and achieve the guided revolutions range.

In other systems operating at the [SAE0] level, tips on economical driving may be offered to the driver. For example, Jaguar® Eco Tips (presented here: http://www.youtube.com/watch?y=CgfvDKL9Gs) or Trakm8® EcoN (described here: http://www.trakm8.com/wp-content/uploads/2013/11/Trakm8_EcoN-FINALlow-res.pdf) indicate to the driver how economically they are driving by offering them a score to try to maximise by changing their driving style and exploring what changes improve their score. However, these systems rely on the driver working out for themselves what changes might help them to achieve a desired level of economy and then experimenting with those changes until a desired result is achieved.

In all of the [SAE0] systems described above, the driver is only given instantaneous guidance that is not specific to a particular journey. Whilst this may help a conscientious driver to make some improvements in the level of economy they achieve, the driver is not given any assistance in achieving a particular desired level of economy over the course of an entire journey.

Furthermore, it can be difficult for a driver to balance the often conflicting demands of achieving a particular desired journey time and a particular desired level of economy to be achieved over the entire journey, and these systems provide no assistance to the driver in that regard.

Other vehicle features that fall within the [SAE0] level include user or system defined speed limiters. Some speed limiter systems provide a visible or audible warning as they approach the speed limit set in the system. Others (such as those implemented in some Heavy Goods Vehicle (HGVs)) may limit the maximum speed of the vehicle. Some systems can change their set speed limit during a journey based on the speed limit of the road. Speed limit data may come from speed limit maps, or traffic sign recognition, or APIs that publish data about active speed limit zones. Some systems offer a tolerance above or below a speed limit, which may be an absolute value (for example, the speed limit set in the speed limiter system is always 5 mph above the speed limit for the road) or a relative value (for example, the speed limit set in the speed limiter system is always 2% below the speed limit for the road).

At level [SAE1] some driver assistance is provided and at level [SAE2] partial automation is provided. However, at both levels, the driver still monitors the driving environment. Systems operating at the [SAE1] level include adaptive cruise control systems and systems operating at the [SAE2] level include lane centring systems. These systems may typically have a target speed and an actual speed. The target speed may be user or system set, in a similar way to the speed limiting systems above. For example, where road speed limits are considered by the system when setting the target speed, the speed limits may be determined using speed limit maps, or traffic sign recognition, or APIs that publish data about active speed zones. An absolute or relative tolerance around the road speed limit may be set by either the user or the system.

In each of these [SAE1] and [SAE2] systems, the driver is given only instantaneous assistance, with no consideration of the driver's objectives for a particular journey. The systems will only help to achieve a particular speed relative to the road speed limit, but will not provide any journey specific assistance, such as helping the driver to arrive at their destination at a particular time and/or achieve a particular level of economy for the journey.

WO 2007/067326 A1 describes an apparatus and method for controlling the airspeed of an aircraft. There may be a number of desired objectives to be met, such as: desired time of arrival at destination; optimising fuel efficiency; and reduction in passengers' perception of airspeed changes of the aircraft. For each objective a recommended airspeed is determined. In consideration of current flight conditions and each of the recommended airspeeds, a resulting airspeed is determined. The resulting airspeed may then be applied to the auto-throttle of the aircraft. Since each recommended airspeed may be different, the resulting airspeed may be a compromise between the various different objectives. Consequently, depending on how compatible the recommended airspeeds are with each other, the compromise may fail to deliver on one or more of the objectives within reasonable tolerances.

The paper “A Genetic Algorithm Based Train Speed Regulation Optimization” by C. Rongwu et. al. (which can be found at: http://www.witpress.com/elibrary/wit-transactions-on-the-built-environment/135/27122) describes a technique for using a genetic algorithm to minimise energy consumption based on a fixed time of travel between signal points and stations. Whilst this system considers both time and energy objectives for a particular section of travel, it is only within the constraints of a rail network, which is a relatively simple, constrained environment that operates on fixed routes with limited potential for traffic disruption. For example, in the rail network, there are no changing traffic concerns, or variable route and distance considerations, or unexpected, uncontrollable behaviour that may affect the journey (such as a third-party vehicle unexpectedly getting in the way of and slowing down the vehicle), etc. Given how different the ‘unconstrained’ road environment is to the ‘constrained’ rail network environment, the teachings of this paper are not straightforwardly applicable to navigation systems for use in navigating unconstrained environments.

US 2016/0258770 describes a process of route selection based on expected energy usage, expected time and/or expected distance. For example, if when planning a route to a destination location, two different routes are expected to result in arrival at the destination location at the same time (based on, for example, road network layout and/or current traffic conditions), the route that is expected to result in the minimal energy usage (based on, for example, elevation changes along the route) may be selected and given to the driver of the vehicle. During the journey, the driver may be given suggested speeds in order to minimise energy usage along the stretch of road on which they are currently driving. For example, the driver may be recommended to drive between about 80% to 95% of the speed limit in order to minimise energy usage. It may be very frustrating for other road users to be regularly held up by vehicles that are being driven by drivers who are being instructed to drive well below the legally allowable speed limits, potentially leading to accidents as frustrated road users attempt to overtake. Also, it may contribute to unnecessary traffic congestion as no consideration is given to the prevailing traffic speeds on the road. Furthermore, setting a particular route and then, whilst that route is being navigated by the vehicle, attempting to achieve short term energy usage goals on a road-by-road basis by suggesting slower speeds may result in a considerably, and unexpectedly, delayed arrival time. Consequently, a driver may start to ignore all speed guidance, for example, because they are aware they are frustrating other road users, or because they know that they will arrive at their destination too late, thereby rendering the system of no use to the driver in achieving efficiency objectives.

All of the navigation systems and energy reduction systems described above take a relatively simple approach to route planning and driver guidance during a route. There is a desire for a more sophisticated system that can provide more assistance in helping to achieve particular objectives for a journey and providing helpful guidance to a driver throughout the journey in order to assist in achieving the objectives. Furthermore, as vehicles become more sophisticated and are equipped with greater levels of automation, through to a fully autonomous, driverless car, more detailed and complex route planning and journey guidance information may be beneficial in helping the vehicle to achieve the desired journey goals.

### SUMMARY

The inventors have realised that existing navigation systems are too simplistic, and do not assist drivers in achieving an overall objective (such as arriving at a destination at a desired time), and also are unable to balance a number of potentially competing objectives, such as, arriving at a destination at a desired time while consuming a minimum of fuel.

For example, existing navigation systems, such as US 2016/0258770, tend to select a route that appears to offer the best journey completion time, or the best energy efficiency in which case it may then straightforwardly guide the driver to drive a particular percentage below the speed limit. This basic speed guidance may be extremely frustrating to the driver, particularly when they need to arrive at the destination by a particular time and the speed guidance gives them no assistance in achieving that goal—it merely assists in trying to reduce energy usage at that moment. Consequently, following the speed guidance may result in the driver arriving late, leading to a general distrust of the speed guidance over time.

The inventors have also realised that simplistic guidance, such as instructing a driver to drive at a particular percentage below the speed limit to reduce fuel consumption on the current stretch of road may not result in the optimum time and energy efficiency outcome for the journey as a whole. By way of example, changing conditions on the road network may mean that it is most energy efficient to drive very quickly for a period of time, in order to avoid efficiency reducing issues later in the journey. For example, a particular stretch of road may be prone to congestion at 5 pm. By driving very quickly for the first half of the journey, that stretch of road may be traversed before 5 pm, thereby avoiding the congestion and improving the overall efficiency of the journey. If the driver simply drives at 80% of the speed limit for the road, they may encounter the congestion and consequently experience a greater energy usage over the entire journey. Thus, it can be seen that such a simplistic approach of energy reduction and speed guidance may not result in sufficiently beneficial outcomes for the driver to consider the guidance helpful and may therefore result in the driver either not using the system, or simply ignoring its advice.

In a first aspect of the present disclosure, there is provided an electronic device (such as a route guidance module, or a route guidance server, or servers comprising ‘the cloud’) for determining a journey guidance policy for use in guidance on a journey from a first location to a second location, the electronic device being configured to: obtain an end objective indicative of an objective to be achieved at the end of the journey at the second location; determine a plurality of probabilistic states for the journey, each probabilistic state comprising: a state location, indicative of a geographical location; and a progress metric; and determine, based at least in part on the plurality of probabilistic states and the end objective, the journey guidance policy, the journey guidance policy comprising the plurality of probabilistic states and a recommended action corresponding to each of the plurality of probabilistic states.

The electronic device may be configured to determine the plurality of probabilistic states as a sequential decision problem (such as a probabilistic sequential decision problem) comprising the plurality of probabilistic states.

Preferably, the sequential decision problem is a Markov Decision Process, a semi-Markov Decision Process or an Interval Markov Decision Process.

The electronic device may be configured to determine the journey guidance policy by solving the sequential decision problem.

The electronic device may be configured to solve the sequential decision problem using at least value iteration and/or policy iteration.

Preferably, the electronic device may be configured to perform an elimination process by: before determining the journey guidance policy, selecting a probabilistic state from the plurality of probabilistic states; assessing whether the end objective can be achieved from the selected probabilistic state based on the state location and a value of the progress metric in the selected probabilistic state; and if the end objective cannot be achieved from the selected probabilistic state, eliminating the selected probabilistic state from the plurality of probabilistic states.

The assessment of whether the end objective can be achieve may be performed using a heuristic function.

The assessment of whether the end objective can be achieved from the selected probabilistic state may be further based on a best case progress (for example, best case time and/or best case efficiency) and/or a worst case progress (for example, worst case time) from the selected probabilistic state to the second location.

Preferably, the electronic device is configured to perform the elimination process during the determination of the plurality of probabilistic states (for example, during constructing of the sequential decision problem).

The electronic device may be configured to: obtain weather data and/or traffic data; and determine each of the plurality of probabilistic states based at least in part on at least part of the weather data and/or traffic data.

The weather data may comprise at least one of: historical weather information; current weather information; forecast weather information; and wherein the traffic data may comprise at least one of: historical traffic information; current traffic information; forecast traffic information.

The electronic device may be configured to: obtain a directed graph of routing options comprising a plurality of nodes and a plurality of interconnecting edges, wherein the directed graph of routing options defines one or more routes from the first location to the second location, wherein the state location of each probabilistic state is indicative of the geographic location of any one of the plurality nodes in the directed graph of routing options.

The interconnecting edges may have an associated attribute and the electronic device may be further configured to: determine each of the plurality of probabilistic states based at least in part on the attributes associated with the plurality of interconnecting edges.

The associated attribute may comprise at least one of: a travelling distance for the part of the journey represented by the associated interconnecting edge; a speed limit for the part of the journey represented by the associated interconnecting edge; a gradient for the part of the journey represented by the associated interconnecting edge.

Each of the plurality of interconnecting edges may be representative of at least part of at least one road in a road network. The associated attribute may comprise at least one of: a type of road represented by the associated interconnecting edge; an indication of a road surface of the road represented by the associated interconnecting edge; an indication of a curvature of the road represented by the associated interconnecting edge.

Preferably, the electronic device is further configured to obtain the directed graph of routing options by: obtaining mapping data comprising a directed graph; creating a coarse directed graph by replacing a segment of the directed graph of the mapping data with a coarse segment; and determining the directed graph of routing options based on the coarse directed graph; wherein the segment comprises two or more initial interconnecting edges of the plurality of initial interconnecting edges; and wherein the coarse segment comprises at least one interconnecting edge, and wherein the number of interconnecting edges in the coarse segment is less than the number of initial interconnecting edges in the segment.

The initial interconnecting edges in the directed graph of the mapping data may have an associated edge attribute, wherein creating the coarse directed graph may comprises: associating a coarse attribute that is based at least in part on at least some of the attributes associated with the interconnecting edges in the segment.

The journey may be a ‘global’ journey, wherein the first location is a start location for the ‘global’ journey, the second location is a ‘destination’ location for the global journey and the end objective is a destination objective. Preferably, the electronic device is further configured to obtain the directed graph of routing options by: obtaining an initial directed graph of routing options comprising a plurality of initial nodes and a plurality of initial interconnecting edges that together define one or more routes from the first location to the second location; and creating the directed graph of routing options by replacing a segment of the initial directed graph with a coarse segment, wherein the segment comprises two or more initial interconnecting edges of the plurality of initial interconnecting edges; and wherein the coarse segment comprises at least one interconnecting edge, and wherein the number of interconnecting edges in the coarse segment is less than the number of initial interconnecting edges in the segment. Each of the initial interconnecting edges in the initial directed graph of routing options may have an associated initial edge attribute. Creating the directed graph of routing options may further comprise: for each of the interconnecting edges in the coarse segment, associating an attribute that is based at least in part on at least some of the initial edge attributes associated with the initial interconnecting edges in the segment.

The journey may be a ‘local’ journey that is part of a ‘global’ journey from a start location to a destination location, wherein at least one of the first location and the second location are intermediate locations on the ‘global’ journey. Preferably, the electronic device is further configured to obtain the directed graph of routing options by: obtaining an initial directed graph of routing options comprising at least one initial interconnecting edge, the initial directed graph of routing options defining one or more routes from the first location to the second location; and creating the directed graph of routing options by replacing a segment of the initial directed graph with a fine segment, wherein the segment comprises one or more of the at least one initial interconnecting edge; and wherein the fine segment comprises two or more interconnecting edges, and wherein the number of interconnecting edges in the fine segment is greater than the number of initial interconnecting edges in the segment. Creating the directed graph of routing options may further comprise: associating an attribute with each of the interconnecting edges in the fine segment.

Preferably, the electronic device is be further configured to: obtain a journey objective; and determine the plurality of probabilistic states based at least in part on the journey objective.

The journey objective may comprise at least one of: (i) a comfort objective; and/or (ii) a legality objective.

Preferably, the end objective comprises at least one of: (i) a punctuality objective; and/or (ii) an efficiency objective.

Preferably, two or more probabilistic states in the plurality of probabilistic states comprise state locations indicative of the same geographical location, but different values of progress metric.

The number of probabilistic states in the plurality of probabilistic states that comprise state locations indicative of the same geographical location, but different values of progress metric may depend on the distance of the geographical location into the journey and/or the complexity of the navigation environment at and/or immediately preceding, the geographical location.

Preferably, the recommended action comprises at last one of: (i) a speed action; and/or (ii) a navigation action.

The electronic device may be is a mobile electronic device (such as a route guidance module, or a smartphone, or a tablet computer).

The electronic device may be for fitting in a vehicle (for example, an ECU, or a module to be interfaced with an ECU).

In a second aspect of the present disclosure, there is provided a vehicle comprising the electronic device.

Alternatively, the electronic device may be a server, or a plurality of interconnected servers (for example, ‘the cloud’).

In a third aspect of the present disclosure, there is provided a route guidance module for use in guidance on a journey from a first location to a second location, the route guidance module being configured to: obtain a journey guidance policy comprising a plurality of probabilistic states for the journey a recommended action corresponding to each of the plurality of probabilistic states; obtain a current journey state; select, based on the current journey state and the plurality of probabilistic states in the journey guidance policy, a recommended action from the journey guidance policy; and output action data based on the selected recommended action, wherein the action data is for use in guiding a next action on the journey.

Preferably, each of the plurality of probabilistic states comprises: a state location, indicative of a geographical location; and a progress metric.

Preferably, the current journey state comprises a current geographic location and a current progress metric.

The route guidance module may be further configured to select the recommended action from the journey guidance policy by: identifying a first set of probabilistic states comprising one or more probabilistic states of the plurality of probabilistic states, wherein the current geographic location is within a proximity threshold of the state location in each probabilistic state in the first set of probabilistic states; and if a value of the current progress metric exceeds a value of the progress metric in each of the probabilistic states in the first set of probabilistic states by more than a failure threshold, performing a failure action; otherwise, identifying a second set of probabilistic states comprising one or more probabilistic states of the first set of probabilistic state, wherein the value of the current progress metric does not exceed a value of the progress metric in each of the probabilistic states in the second set of probabilistic states by more than the failure threshold; and selecting a recommended action corresponding to one of the probabilistic states in the second set of probabilistic states.

Preferably, selecting a recommended action corresponding to one of the probabilistic states in the second set of probabilistic states is based at least in part on the value of the current progress metric and the value of the progress metric in each of the probabilistic states in the second set of probabilistic states.

The route guidance module may be further configured to select the recommended action from the journey guidance policy by: identifying a first set of probabilistic states comprising one or more probabilistic states of the plurality of probabilistic states, wherein the current geographic location is within a proximity threshold of the state location in each probabilistic state in the first set of probabilistic states; extrapolating a value current progress metric to an extrapolated value, wherein the extrapolated value is the value of the current progress metric extrapolated to that expected on arrival at the state location in the first set of probabilistic states; and if the extrapolated value exceeds a value of the progress metric in each of the probabilistic states in the first set of probabilistic states by more than a failure threshold, performing a failure action; otherwise, identifying a second set of probabilistic states comprising one or more probabilistic states of the first set of probabilistic state, wherein the extrapolated value does not exceed a value of the progress metric in each of the probabilistic states in the second set of probabilistic states by more than the failure threshold; and selecting a recommended action corresponding to one of the probabilistic states in the second set of probabilistic states.

The route guidance module may be further configured to select a recommended action corresponding to one of the probabilistic states in the second set of probabilistic states based at least in part on the extrapolated value and the value of the progress metric in each of the probabilistic states in the second set of probabilistic states.

The failure action may comprise obtaining a new journey guidance policy for a journey from the current geographic location to the second location.

The route guidance module may be further configured to obtain the journey guidance policy after the guidance has already commenced (for example, whilst the journey guidance policy is being determined, the journey may be started and then once the journey guidance policy is determined and it is obtained by the route guidance module, it may then be used for the remainder of the journey).

Preferably, t progress metric comprises at least one of: (i) a time metric; and/or (ii) an efficiency metric.

The journey may be a ‘global’ journey, wherein the first location is a start location for the ‘global’ journey, the second location is a ‘destination’ location for the global journey and the journey guidance policy is a ‘global’; journey policy.

Alternatively, the journey may be a ‘local’ journey that is part of a ‘global’ journey from a start location to a destination location, and wherein at least one of the first location and the second location are intermediate locations on the global journey.

Preferably, the recommended action comprises at last one of: (i) a speed action; and/or (ii) a navigation action.

Preferably, the route guidance module is for use in guiding a vehicle on the journey. If the vehicle is a driver operated vehicle, and the route guidance module may be further configured to: output action data at a time that is determined based at least in part on a driver ID that identifies the driver of the vehicle.

In a fourth aspect of the present disclosure, there is provided a route guidance module for use in guidance on a ‘global’ journey from a start location to a destination location, the route guidance module being configured to: obtain a ‘global’ journey policy comprising a plurality of probabilistic states for the ‘global’ journey and a recommended action for each of the probabilistic states, wherein the recommended action comprises a next probabilistic state; obtain a current journey state; select, based on the current journey state and the plurality of probabilistic states in the ‘global’ journey policy, a recommended action from the ‘global’ journey policy; obtain a ‘local’ journey policy for a portion of the ‘global’ journey from the current state to the next probabilistic state in the selected recommended action from the ‘global’ journey policy, wherein the ‘local’ journey policy comprises a plurality of probabilistic states for the ‘local’ journey and a recommended action for each of the probabilistic states; select, based on the current journey state and the plurality of probabilistic states in the ‘local’ journey policy, a recommended action from the ‘local’ journey policy; and output action data based on the selected recommended action from the ‘local’ journey policy, wherein the action data is for use in guiding a next action on the ‘local’ journey.

The route guidance module of the third and/or fourth aspects may be a mobile electronic device (such as a mobile route guidance module, or a smartphone, or a tablet computer), or may be for fitting in a vehicle (for example, and ECU or a module for interface with an ECU).

In a fifth aspect of the present disclosure, there is provided a vehicle comprising the route guidance module.

In a sixth aspect of the present disclosure, there is provided a method for determining a journey guidance policy for use in guidance on a journey from a first location to a second location, the method comprising: obtaining an end objective indicative of an objective to be achieved at the end of the journey at the second location; determining a plurality of probabilistic states for the journey, each probabilistic state comprising: a state location, indicative of a geographical location; and a progress metric; and determining, based at least in part on the plurality of probabilistic states and the end objective, the journey guidance policy, the journey guidance policy comprising the plurality of probabilistic states and a recommended action corresponding to each of the plurality of probabilistic states.

The plurality of probabilistic states may be determined as a sequential decision problem (for example, a probabilistic sequential decision problem) comprising the plurality of probabilistic states.

Preferably, the sequential decision problem is a Markov Decision Process, a semi-Markov Decision Process or an Interval Markov Decision Process.

Determining the journey guidance policy may comprise solving the sequential decision problem.

The sequential decision problem may be solved using at least value iteration and/or policy iteration.

Preferably, the method further comprises: performing an elimination process, wherein the elimination process comprises: before determining the journey guidance policy, selecting a probabilistic state from the plurality of probabilistic states; assessing whether the end objective can be achieved from the selected probabilistic state based on the state location and a value of the progress metric in the selected probabilistic state; and if the end objective cannot be achieved from the selected probabilistic state, eliminating the selected probabilistic state from the plurality of probabilistic states.

The assessment of whether the end objective can be achieved may be performed using a heuristic function.

The assessment of whether the end objective can be achieved from the selected probabilistic state may be further based on a best case progress (for example, a best case time and/or a best case efficiency) and/or a worst case progress (for example, a worst case time) from the selected probabilistic state to the second location.

Preferably, the elimination process is performed whilst determining the plurality of probabilistic states (for example, during construction of a sequential decision problem).

The method may further comprise: obtaining weather data and/or traffic data; and determining each of the plurality of probabilistic states based at least in part on at least part of the weather data and/or traffic data.

The weather data may comprise at least one of: historical weather information; current weather information; forecast weather information; and wherein the traffic data comprise at least one of: historical traffic information; current traffic information; forecast traffic information.

The method may further comprise: obtaining a directed graph of routing options comprising a plurality of nodes and a plurality of interconnecting edges, wherein the directed graph of routing options defines one or more routes from the first location to the second location, wherein the state location of each probabilistic state is indicative of the geographic location of any one of the plurality nodes in the directed graph of routing options.

Each of the interconnecting edges may have an associated attribute and the method may further comprise: determining each of the plurality of probabilistic states based at least in part on the attributes associated with the plurality of interconnecting edges.

The associated attribute may comprise at least one of: a travelling distance for the part of the journey represented by the associated interconnecting edge; a speed limit for the part of the journey represented by the associated interconnecting edge; a gradient for the part of the journey represented by the associated interconnecting edge.

The plurality of interconnecting edges may be representative of at least part of at least one road in a road network. The associated attribute may comprise at least one of: a type of road represented by the associated interconnecting edge; an indication of a road surface of the road represented by the associated interconnecting edge; an indication of a curvature of the road represented by the associated interconnecting edge.

Preferably, obtaining the directed graph of routing options comprises: obtaining mapping data comprising a directed graph; creating a coarse directed graph by replacing a segment of the directed graph of the mapping data with a coarse segment; and determining the directed graph of routing options based on the coarse directed graph; wherein the segment comprises two or more initial interconnecting edges of the plurality of initial interconnecting edges; and wherein the coarse segment comprises at least one interconnecting edge, and wherein the number of interconnecting edges in the coarse segment is less than the number of initial interconnecting edges in the segment.

Each of the initial interconnecting edges in the directed graph of the mapping data may have an associated edge attribute, wherein creating the coarse directed graph may comprise: associating a coarse attribute that is based at least in part on at least some of the attributes associated with the interconnecting edges in the segment.

The journey may be a ‘global’ journey, wherein the first location is a start location for the ‘global’ journey, the second location is a ‘destination’ location for the global journey and the end objective is a destination objective. Preferably, obtaining the directed graph of routing options may comprise: obtaining an initial directed graph of routing options comprising a plurality of initial nodes and a plurality of initial interconnecting edges that together define one or more routes from the first location to the second location; and creating the directed graph of routing options by replacing a segment of the initial directed graph with a coarse segment, wherein the segment comprises two or more initial interconnecting edges of the plurality of initial interconnecting edges; and wherein the coarse segment comprises at least one interconnecting edge, and wherein the number of interconnecting edges in the coarse segment is less than the number of initial interconnecting edges in the segment. Each of the initial interconnecting edges in the initial directed graph of routing options may have an associated initial edge attribute. Creating the directed graph of routing options may further comprise for each of the interconnecting edges in the coarse segment, associating an attribute that is based at least in part on at least some of the initial edge attributes associated with the initial interconnecting edges in the segment.

The journey may be a ‘local’ journey that is part of a ‘global’ journey from a start location to a destination location, wherein at least one of the first location and the second location are intermediate locations on the ‘global’ journey. Obtaining the directed graph of routing options may comprise: obtaining an initial directed graph of routing options comprising at least one initial interconnecting edge, the initial directed graph of routing options defining one or more routes from the first location to the second location; and creating the directed graph of routing options by replacing a segment of the initial directed graph with a fine segment, wherein the segment comprises one or more of the at least one initial interconnecting edge; and wherein the fine segment comprises two or more interconnecting edges, and wherein the number of interconnecting edges in the fine segment is greater than the number of initial interconnecting edges in the segment. Creating the directed graph of routing options may further comprise: associating an attribute with each of the interconnecting edges in the fine segment.

Preferably, the method further comprises: obtaining a journey objective; and determining the plurality of probabilistic states based at least in part on the journey objective. The journey objective may comprise at least one of: (i) a comfort objective; and/or (ii) a legality objective.

Preferably, the end objective comprises at least one of: (i) a punctuality objective; and/or (ii) an efficiency objective.

Preferably, two or more probabilistic states in the plurality of probabilistic states comprise state locations indicative of the same geographical location, but different values of progress metric.

The number of probabilistic states in the plurality of probabilistic states that comprise state locations indicative of the same geographical location, but different values of progress metric, may depend on the distance of the geographical location into the journey and/or the complexity of the navigation environment at and/or immediately preceding, the geographical location.

Preferably. the recommended action comprises at last one of: (i) a speed action; and/or (ii) a navigation action.

In a seventh aspect of the present disclosure, there is provided an electronic device configured to perform the method of the sixth aspect. The electronic device may be a mobile electronic device, or may be for fitting in a vehicle.

In an eighth aspect of the present disclosure, there is provided a vehicle comprising the electronic device.

Alternatively, the electronic device may be a server, or a plurality of interconnected servers

In a ninth aspect of the present disclosure, there is a computer program configure to perform the method of the sixth aspect when executed on a processor of an electronic device.

In a tenth aspect of the present disclosure, there is provided a method for providing guidance on a journey from a first location to a second location, the method comprising: obtaining a journey guidance policy comprising a plurality of probabilistic states for the journey a recommended action corresponding to each of the plurality of probabilistic states; obtaining a current journey state; selecting, based on the current journey state and the plurality of probabilistic states in the journey guidance policy, a recommended action from the journey guidance policy; and outputting action data based on the selected recommended action, wherein the action data is for use in guiding a next action on the journey.

Preferably, each of the plurality of probabilistic states may comprise: a state location, indicative of a geographical location; and a progress metric.

Preferably, the current journey state comprises a current geographic location and a current progress metric.

Selecting the recommended action from the journey guidance policy may comprise: identifying a first set of probabilistic states comprising one or more probabilistic states of the plurality of probabilistic states, wherein the current geographic location is within a proximity threshold of the state location in each probabilistic state in the first set of probabilistic states; and if a value of the current progress metric exceeds a value of the progress metric in each of the probabilistic states in the first set of probabilistic states by more than a failure threshold, performing a failure action; otherwise, identifying a second set of probabilistic states comprising one or more probabilistic states of the first set of probabilistic state, wherein the value of the current progress metric does not exceed a value of the progress metric in each of the probabilistic states in the second set of probabilistic states by more than the failure threshold; and selecting a recommended action corresponding to one of the probabilistic states in the second set of probabilistic states.

Preferably, selecting a recommended action corresponding to one of the probabilistic states in the second set of probabilistic states is based at least in part on the value of the current progress metric and the value of the progress metric in each of the probabilistic states in the second set of probabilistic states.

Selecting the recommended action from the journey guidance policy may comprise: identifying a first set of probabilistic states comprising one or more probabilistic states of the plurality of probabilistic states, wherein the current geographic location is within a proximity threshold of the state location in each probabilistic state in the first set of probabilistic states; extrapolating a value current progress metric to an extrapolated value, wherein the extrapolated value is the value of the current progress metric extrapolated to that expected on arrival at the state location in the first set of probabilistic states; and if the extrapolated value exceeds a value of the progress metric in each of the probabilistic states in the first set of probabilistic states by more than a failure threshold, performing a failure action; otherwise, identifying a second set of probabilistic states comprising one or more probabilistic states of the first set of probabilistic state, wherein the extrapolated value does not exceed a value of the progress metric in each of the probabilistic states in the second set of probabilistic states by more than the failure threshold; and selecting a recommended action corresponding to one of the probabilistic states in the second set of probabilistic states.

Selecting a recommended action corresponding to one of the probabilistic states in the second set of probabilistic states may be based at least in part on the extrapolated value and the value of the progress metric in each of the probabilistic states in the second set of probabilistic states.

The failure action may comprise obtaining a new journey guidance policy for a journey from the current geographic location to the second location.

The journey guidance policy may be obtained after the guidance has already commenced.

Preferably, the progress metric comprises at least one of: (i) a time metric; and/or (ii) an efficiency metric.

The journey may be a ‘global’ journey, wherein the first location is a start location for the ‘global’ journey, the second location is a ‘destination’ location for the global journey and the journey guidance policy is a ‘global’; journey policy.

The journey may be a ‘local’ journey that is part of a ‘global’ journey from a start location to a destination location, wherein at least one of the first location and the second location are intermediate locations on the global journey.

Preferably, the recommended action comprises at last one of (i) a speed action; and/or (ii) a navigation action.

Preferably, the method is for use in guiding a vehicle on the journey. Where the vehicle is a driver operated vehicle, the method may further comprise: outputting action data at a time that is determined based at least in part on a driver ID that identifies the driver of the vehicle.

In an eleventh aspect of the present disclosure, there is provided an electronic device configured to perform the method of the tenth aspect. The electronic device may be mobile electronic device or an electronic device for fitting in a vehicle.

In a twelfth aspect of the present disclosure, there is provided a vehicle comprising the electronic device of the eleventh aspect.

Alternatively, the electronic device may be a server, or a plurality of interconnected servers.

In a thirteenth aspect of the present disclosure, there is provided a computer program configured to perform the method of the tenth aspect when executed on a processor of an electronic device.

In a fourteenth aspect of the present disclosure, there is provided a method for providing guidance on a ‘global’ journey from a start location to a destination location, the method comprising: obtaining a ‘global’ journey policy comprising a plurality of probabilistic states for the ‘global’ journey and a recommended action for each of the probabilistic states, wherein the recommended action comprises a next probabilistic state; obtaining a current journey state; selecting, based on the current journey state and the plurality of probabilistic states in the ‘global’ journey policy, a recommended action from the ‘global’ journey policy; obtaining a ‘local’ journey policy for a portion of the ‘global’ journey from the current state to the next probabilistic state in the selected recommended action from the ‘global’ journey policy, wherein the ‘local’ journey policy comprises a plurality of probabilistic states for the ‘local’ journey and a recommended action for each of the probabilistic states; selecting, based on the current journey state and the plurality of probabilistic states in the ‘local’ journey policy, a recommended action from the ‘local’ journey policy; and outputting action data based on the selected recommended action from the ‘local’ journey policy, wherein the action data is for use in guiding a next action on the ‘local’ journey.

In a fifteenth aspect of the present disclosure, there is provided an electronic device configured to perform the method of the fourteenth aspect. The electronic device may be a mobile electronic device or an electronic device for fitting in a vehicle.

In a sixteenth aspect of the present disclosure, there is provided a vehicle comprising the electronic device of the fifteenth aspect.

In a seventeenth aspect of the present disclosure, there is provided a computer program configured to perform the method of the fourteenth aspect when executed on a processor of an electronic device.

In an eighteenth aspect of the present disclosure, there is provided a route guidance system for providing guidance on a journey from a first location to a second location, the route guidance system comprising: an electronic device configured to: obtain an end objective indicative of an objective to be achieved at the end of the journey at the second location; determine a plurality of probabilistic states for the journey, each probabilistic state comprising: a state location, indicative of a geographical location; and a progress metric; and determine, based at least in part on the plurality of probabilistic states and the end objective, the journey guidance policy, the journey guidance policy comprising the plurality of probabilistic states and a recommended action corresponding to each of the plurality of probabilistic states; and a route guidance module configured to: obtain the journey guidance policy from the electronic device; obtain a current journey state; select, based on the current journey state and the plurality of probabilistic states in the journey guidance policy, a recommended action from the journey guidance policy; and output action data based on the selected recommended action, wherein the action data is for use in guiding a next action on the journey.

### DRAWINGS

Aspects of the disclosure are described, by way of example only, with reference to the following drawings, in which:

FIG. 1 shows an example route guidance system;

FIG. 2 shows a representation of a process hierarchy of the present disclosure;

FIG. 3 shows a representation of an example process of determining a journey definition;

FIG. 4 shows an representation of an example process of determining a nominal journey understanding during the determination of a journey definition represented in FIG. 3;

FIG. 5 shows an example representation of a road network identifying a start location A and a destination location B;

FIG. 6 shows an example representation of a directed graph of the road network of FIG. 5;

FIG. 7 shows an example representation of a directed graph of potential routes from the start location A to the destination location B of the road network of FIG. 5;

FIG. 8 shows an example user interface for inputting journey objectives and destination objectives as part of the process of determining the journey definition represent in FIG. 3.

FIG. 9 shows an example representation of a directed graph of routing options from the start location A to the destination location B of the road network of FIG. 5;

FIG. 10 shows a representation of an example alternative process of determining a journey definition in accordance with the present disclosure;

FIG. 11 shows an example alternative user interface for inputting journey objectives and destination objectives as part of the process of determining the journey definition represented in FIG. 10;

FIG. 12 shows a representation of an example process of determining a ‘global’ journey policy;

FIG. 13 shows a representation of the determination of a plurality of probabilistic states as part of the process of determining the ‘global’ journey policy of FIG. 12;

FIG. 14 a further representation of the directed graph of routing options from the start location A to the destination location B of the road network of FIG. 5;

FIG. 15 shows a Markov Decision Process during the determination of a plurality of probabilistic states represented in FIG. 13;

FIG. 16 shows a development of the Markov Decision Process of FIG. 15 during the determination of the plurality of probabilistic states represented in FIG. 13;

FIG. 17 shows a development of the Markov Decision Process of FIG. 16 during the determination of the plurality of probabilistic states represented in FIG. 13;

FIG. 18 shows a representation of the replacement of segments comprising interconnecting edges with coarse segments;

FIG. 19 shows a representation of the determination of recommended actions as part of the process of determining the ‘global’ journey policy of FIG. 12;

FIG. 20 shows a representation of to use of a ‘global’ journey policy during a ‘global’ journey;

FIG. 21 shows a representation of a user interface displaying recommended driving actions for a journey;

FIG. 22 shows a representation of an example process of determining a ‘local’ journey policy; and

FIG. 23 shows a representation of the replacement of a segment with a fine segment comprising a plurality of interconnecting edges.

It will be appreciated that the drawings are highly schematic and are not drawn to scale.

### DETAILED DESCRIPTION

The present disclosure relates to the generation and use of journey guidance policies for a journey from a first location to a second location. Unlike traditional navigation systems that are limited to providing navigation instructions for executing a route that is fixed before the journey begins, the route guidance system of the present disclosure can provide more extensive guidance that includes route actions (for example, navigation instructions, such as ‘turn left’, ‘turn right’, etc) and speed actions, all with the aim of achieving objectives that can be set by the user (for example, a desired arrival time(s) at the second location, a desired level(s) energy consumption to get to the second location, a level of comfort that they would like for the journey, the extent to which they would like to keep within speed limits, etc).

Rather than fixing a particular route and/or speed profile at the start of the journey, the present disclosure takes a probabilistic approach, whereby a ‘global’ journey policy is used to identify the best action to take next (for example, what route action to take at a junction, what speed to go at for the next part of the journey, etc) based on how well the journey has progressed so far against time and/or efficiency objectives that have been set for the journey. Consequently, the guidance is considerably more adaptable to changing conditions during the journey (for example, changing levels of traffic and/or changing weather conditions, which may affect how the journey progresses), thereby improving the likelihood of achieving the objectives that have been set for the journey.

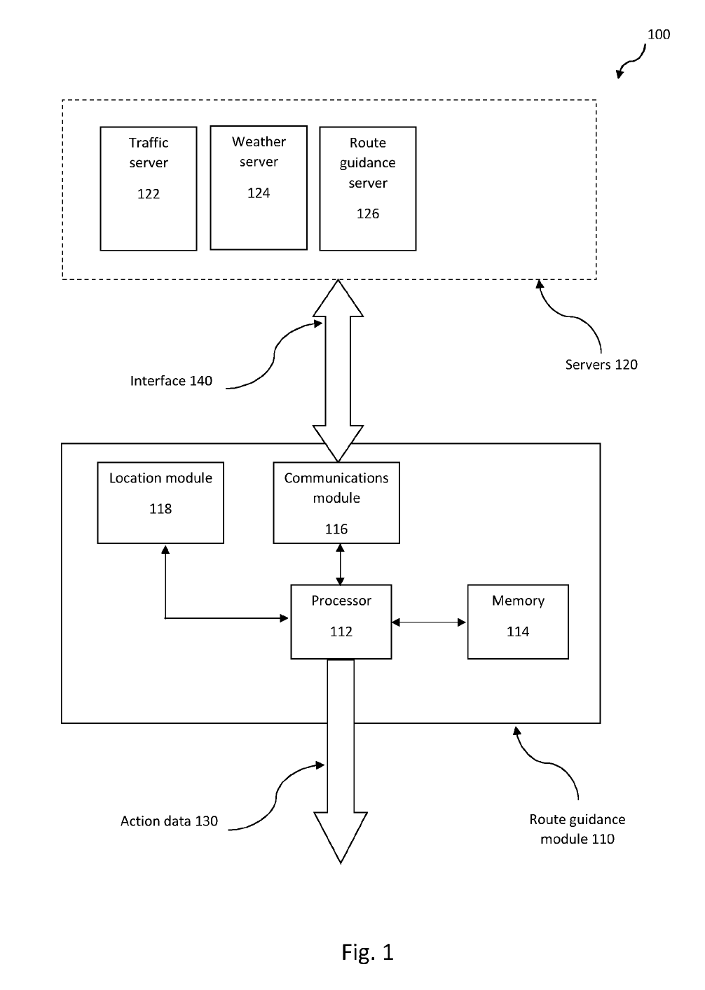

FIG. 1 shows a representation of an example route guidance system 100 comprising a route guidance module 110 and a collection of servers 120. The route guidance module 110 is designed to be located in a vehicle to assist with guiding the vehicle on a journey from a start location to a destination location.

As well as designating a start location and a destination location for the journey, a user (such as a driver or other occupant in the vehicle) can define other desired objectives for the journey. These desired objectives may be objectives relating to the journey (journey objectives), such as comfort and attitude to speed limits. The desired objectives may additionally, or alternatively, be objectives relating to the destination (destination objectives), such as desired punctuality (such as an arrival time, or arrival time window) and desired energy efficiency.

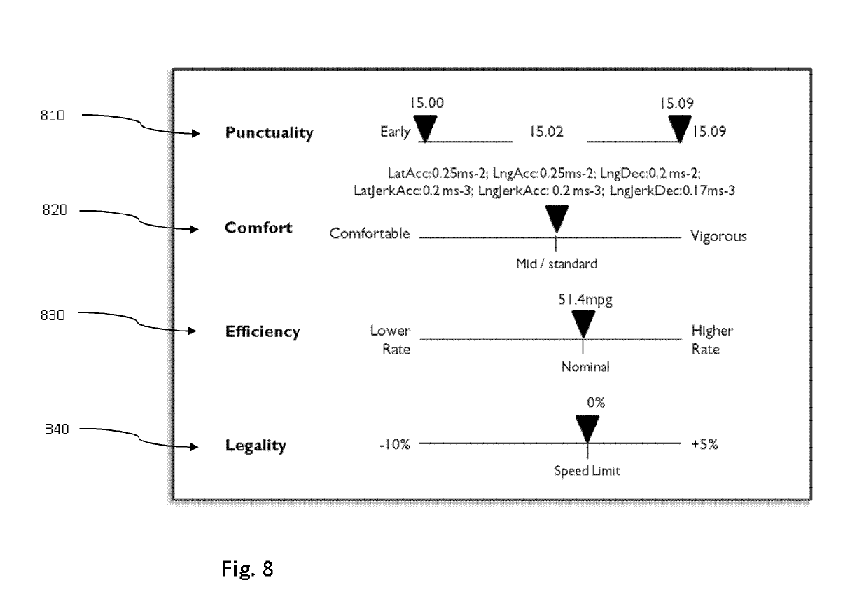

The user may define the desired objectives using a user interface on the route guidance module (such as the user interface illustrated in FIG. 8). In the example represented in FIG. 8 (and explained in more detail later in the description), the user defines the desired objectives by manipulating the sliders on the user interface 150 to desired values.

The route guidance module 110 may be fitted to the vehicle, or it may be a portable device that is kept in the vehicle for at least the duration of the journey. For example, it may be installed as an integral component to a vehicle at the time of manufacture of the vehicle (for example, it may be part of an engine control unit (ECU)), or it may be retrofitted as an integral component to a vehicle sometime after manufacture of the vehicle (for example, as a retro-fit component that interfaces with the vehicle, such as with the ECU of the vehicle and/or with the communications bus of the vehicle, etc). Alternatively, it may be a standalone, portable module that an operator can have within the cabin of the vehicle. For example, the route guidance module 110 may be a purpose built navigation device—sometimes referred to as a ‘Sat Nay’- or it may be a generic portable electronic device (such as a smartphone, or tablet computer, etc) that is configured to perform the operations described below (for example, by virtue of software stored on the route guidance module 110 that, when executed on a processor of the route guidance module 110, causes the processor to carry out the operations described below).

The route guidance module 110 comprises a processor 112 that interfaces with memory 114, a communications module 116 and a location module 118. The processor 112 may comprise any suitable form of processor or logic, such as a microprocessor, or programmable logic, etc. The memory 114 may comprise any suitable form of memory, for example volatile memory such as Random Access Memory (RAM), or non-volatile memory, such as Read Only Memory (ROM), flash memory, solid-state storage, mechanical memory (such as a hard disk), etc. The memory 114 may be fixed in the route guidance module 110 or may be removable, such as a Secure Digital (SD) card. The communications module 116 may be configured to enable data communications (inbound and/or outbound) between the route guidance module 110 and one or more external entities (for example, one or more servers in the collection of servers 120) using one or more different communications protocols, standards or architectures. For example, the communications module may enable communications using one or more wireless communications protocols/standards, such as Bluetooth®, Wi-Fi, WiMAX and/or mobile telecommunications standards such as GPRS, EDGE, UMTS, HSPA, LTE, 4G, etc. The location module 118 may utilise any suitable technology to identify the current location of the route guidance module 110 (and optionally also the current time). For example, it may be configured to utilise one or more global navigation satellite systems (GNSS) (such as the Global Positioning System (GPS), GLONASS, the Galileo positioning system, BeiDou and/or Navic), and/or one or more terrestrial positioning systems (such as: LiDAR and/or RADAR to determine the size, shape and distance between objects in the environment on which triangulation of position may be based; image recognition to scan the road ahead and identify unique ‘fingerprints’ in the road to determine position; and/or beacon triangulation).

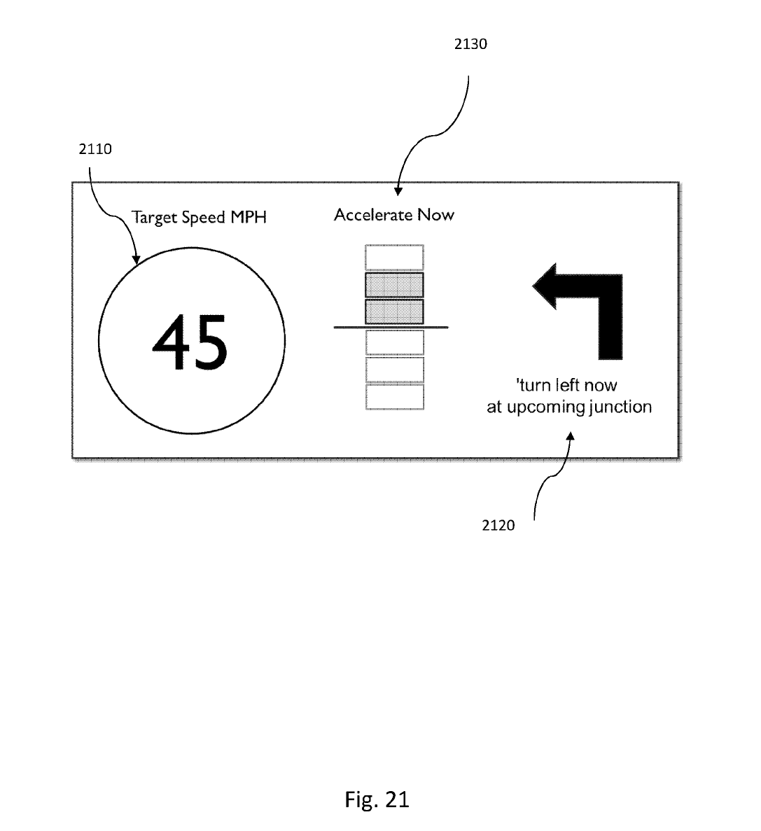

The processor 112 is configured to output action data 130 indicative of at least one recommended action. A recommended action may be a turn or direction recommendation (navigation action) and/or a speed action. By providing recommended actions, the route guidance system 100 helps the vehicle complete the journey while also achieving the objectives for the journey.

Where a vehicle is being operated by a person, the speed action may comprise a ‘recommended speed’ to be communicated to the driver (for example, audibly and/or visually). Where the vehicle operates according to [SAE0], the speed action may comprise a ‘speed limit’, to be set by the vehicle so that the driver of the vehicle cannot exceed that speed. Where the vehicle operates according to [SAE1]-[SAE5], the speed action may comprise a ‘target speed’ for the vehicle to attempt to achieve. In the following description, for the sake of simplicity, the speed action is generally described as being indicative of a ‘target speed’. However, it will be appreciated that the speed action could additionally, or alternatively, be indicative of a ‘speed limit’ and/or a ‘recommended speed’. The driving action data 130 may be output for communication to a driver of the vehicle, for example by audio and/or visual means. In that case, the route guidance module 110 may further comprise a display screen, such as the example display screen shown in FIG. 21. The display screen may be, for example, an LED display, an OLED display, an LCD display, a plasma display, etc, for displaying the recommended action. Additionally, or alternatively, the route guidance module 100 may further comprise an audio output device (such as a speaker) for outputting an audible description of the recommended action. A display screen and/or audio output device are not represented in FIG. 1 for the sake of simplicity. Additionally, or alternatively, the vehicle may comprise a display screen and/or audio output device, in which case the action data 130 may be output to the vehicle for communication of the recommended action to the driver via the vehicle's display screen and/or audio output device. Additionally, or alternatively, the action data 130 may be output to any other type of visual display and/or audio device, such as augmented reality glasses or a vehicle head-up-display.

Additionally, or alternatively, the driving action data 130 may be output for use by an [SAE0] vehicle (for example, to set a speed limiter), or for use by an [SAE1]-[SAE5] vehicle, for automated control of the vehicle. In these cases, the driving action data 130 may be output to a control module within the vehicle.

The collection of servers 120 represented in FIG. 1 comprises a traffic server 122, a weather server 124 and a route guidance server 126. The traffic server 122 may be used to provide traffic data comprising current traffic information that is indicative of current traffic levels on a road-network, historical traffic information that is indicative of historical traffic levels on a road network and/or forecast traffic information that is indicative of predicted future levels of traffic on a road network. The weather server 124 may be used to provide weather data comprising current weather information indicative of localised current weather, historical weather information indicative of localised historic weather and/or forecast weather information indicative of localised predicted future weather (for example, temperature and/or precipitation and/or ground conditions). The route guidance server 126 may be a server that is maintained and run by, for example, a service provider for the route guidance module 110 (for example, the manufacturer of the route guidance module 110) and may be, for example, a device management (DM) server for the route guidance module 110. The data that may be communicated between the route guidance server 126 and the route guidance module 110 are explained later in the detailed description.

The data interface 140 between the communications module 116 and the servers 120 may be a collection of interfaces, for example a separate interface between each of the servers and the communications module 116, ora single interface between the communications module 116 and one of the servers (such as the route guidance server 126). Optionally, the different servers may communicate with each other via interfaces (not represented in FIG. 1). For example, the route guidance server 126 may interface with the traffic information server 122 and/or the weather information server 124 to obtain traffic data and/or weather data to be communicated to the communications module 116 via the interface 140.

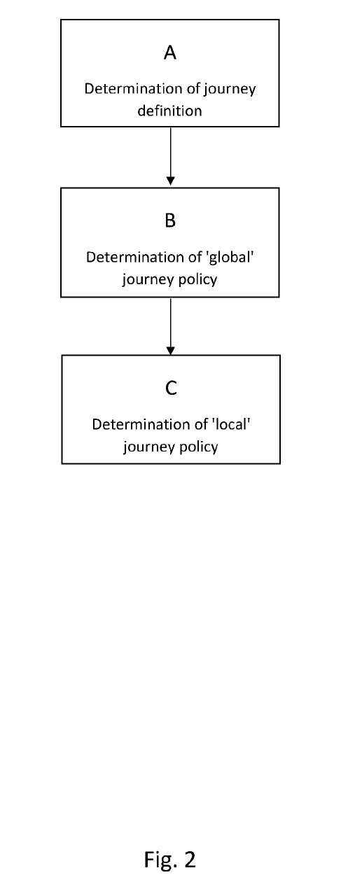

FIG. 2 shows an example process hierarchy of aspects of the present disclosure. The hierarchy comprises the determination of a journey definition (part A), the determination of a ‘global’ journey policy (part B) and the determination of a ‘local’ journey policy (part C). The determination of a ‘global’ journey policy may utilise the determined journey definition and the determination of a ‘local’ journey policy may utilise the determined ‘global’ journey policy. However, it will be appreciated from an understanding of the whole disclosure that each of parts A, B and C are not reliant on each other. For example, the ‘global’ journey policy (part B) may be determined without the determination of the journey definition (part A) and/or the ‘local’ journey policy (part C) may be determined without the determination of the journey definition (part A) and/or the determination of the ‘global’ journey policy (part B).

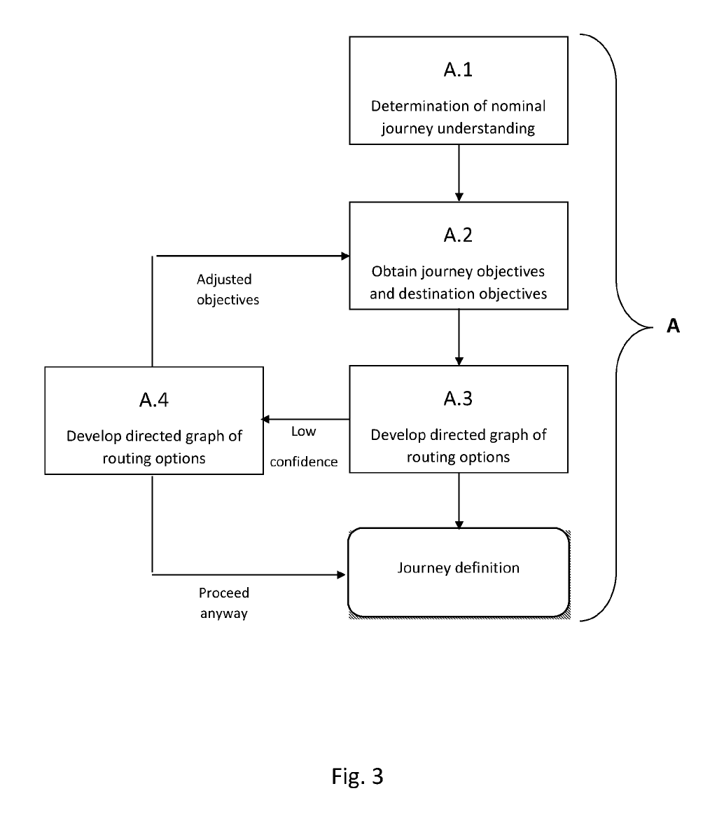

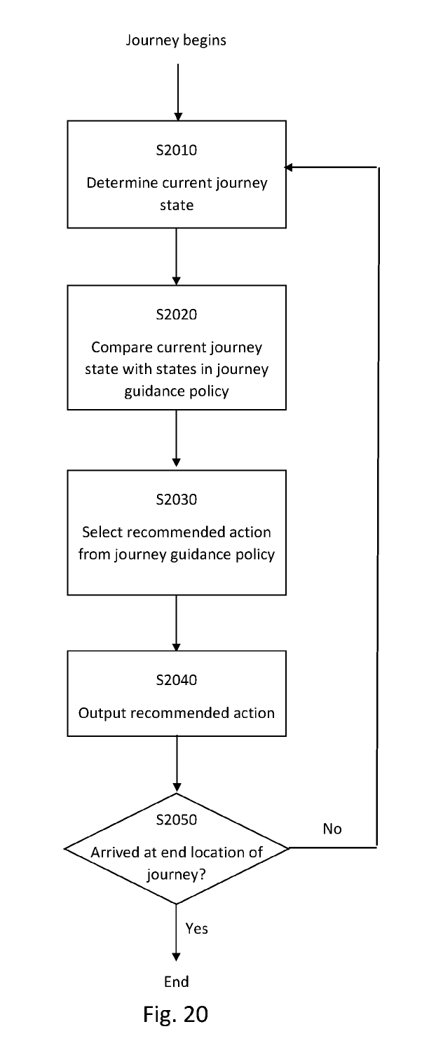

Process steps for the determination of a journey definition (part A), the determination of a ‘global’ journey policy (part B) and the determination of a ‘local’ journey policy (part C) shall be described with references to FIGS. 3-19, 22 and 23 and shall be based on a scenario where a driver wishes to make a single ‘global’ journey from a start location A to a destination location B (therefore, a ‘global’ journey may alternatively be referred to as an entire journey, from start location A to destination location B), where the route guidance module 110 receives input data from the driver (for example, via an voice recognition system in the route guidance module 110 and/or via a touchscreen interface on the route guidance module 110 and/or via capacitive buttons on the route guidance module 110 and/or via push buttons on the route guidance module 110, etc). Subsequently, as explained with reference to FIGS. 20 and 21, route guidance may be communicated to the driver may be route guidance module to help guide them throughout the ‘global’ journey. As such, each of the steps described below may be executed by the processor 112 of the route guidance module 110, for example using a set of instructions in software stored in memory module 114.

However, as is explained later in the description, this is only one particular non-limiting example and other entities (such as the route guidance server 126) may alternatively carry out some or all of the processes for parts A, B and/or C. Furthermore, the parts A, B and/or C may carried out for purposes other than a driver wishing to make a single ‘global’ journey from a start location A to a destination location B, such as a single ‘global’ journey from a start location A to a destination location B via one or more waypoints, or a vehicle manager (such as a taxi dispatcher) wishing to guide a driver on a journey that they would like the driver to make, etc.

In the present disclosure, the term ‘global’ journey is used to identify a journey from a start location to a destination location, whereas ‘local’ journey is used to identify a journey that is part of a ‘global’ journey, the ‘local’ journey being between a first location and a second location wherein at least one of the first location and second location are intermediate locations between the start location and the destination location of the ‘global’ journey (therefore, a ‘local’ journey may alternatively be referred to as a part of a ‘global’, or entire, journey, from a first location to a second location).

A Determination of Journey Definition

The first step, A, in the process represented in FIG. 2 is the determination of a journey definition.

FIG. 3 shows a representation of example process steps that may be undertaken to determine the journey definition (part A in FIG. 2). The process steps represented in FIG. 3 comprise determining a nominal journey understanding (part A.1), obtaining journey objectives and destination objectives (part A.2) and development of a directed graph that is representative of routing options. Each of these process steps is described in detail below.

The destination objectives are a particular type of end objective. Destination objectives relate to objectives to be achieved on arrival at the destination location of the ‘global’ journey. A different, but analogous, type of end objectives may relate to objectives to be achieved at the end of a ‘local’ journey.

A.1 Determination of a Nominal Journey Understanding

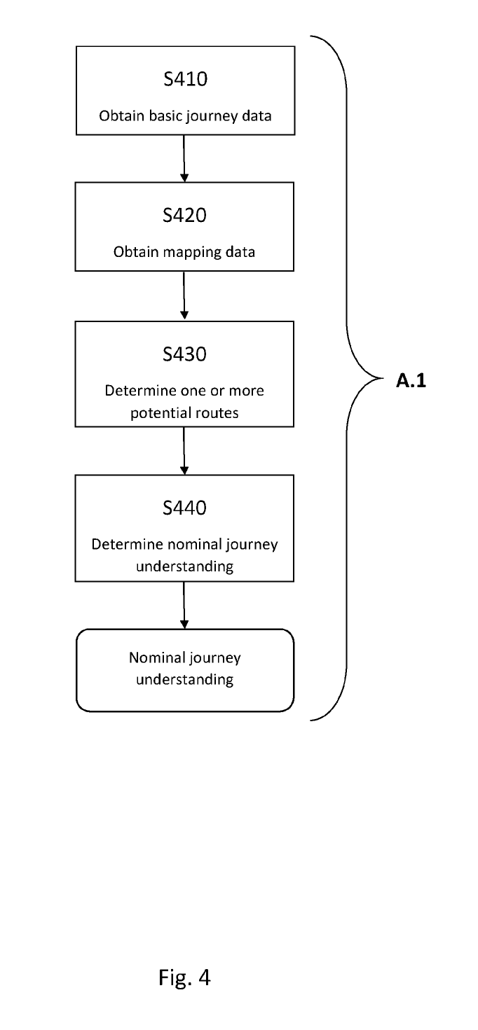

FIG. 4 shows a representation of example process steps for the determination of a nominal journey understanding (part A.1 in FIG. 3).

In Step S410 of FIG. 4, basic journey data is obtained. The basic journey data comprises a start location for the ‘global’ journey and a destination location for the ‘global’ journey. The start location may be obtained by the user of the route guidance module 110 inputting the location at which they would like to start their ‘global’ journey (for example, a post code, or ZIP code, or street address, or GPS co-ordinates, etc), via a user interface of the route guidance module 110, such as a touch screen, or push-buttons, or voice recognition system, etc. Alternatively, the start location may be obtained by setting the start location to be the current location of the route guidance module 110, as indicated by the location module 118 (for example, in GPS co-ordinates). The destination location may be obtained by the user of the route guidance module 110 inputting the location at which they would like to end their ‘global’ journey—i.e., their desired destination—(for example, a post code, or ZIP code, or street address, or GPS co-ordinates, etc), via a user interface of the route guidance module 110, such as a touch screen, or push-buttons, or voice recognition system, etc. Alternatively, the destination location may be obtained by learning user patterns, for example the route guidance module 110 may learn particular ‘global’ journeys that the user undertakes at particular times of day (such as weekday commuting from home to work at 8 am and from work to home at 5 pm) and store an understanding of this in the memory module 114. The processor 112 may then obtain the destination location by looking up the learned destination locations in the memory module 114 and, if the criteria associated with a particular destination location is met (for example, the current time and day match the criteria for commuting to work), the destination location is set to the learned destination location, unless the user instructs otherwise.

The basic journey data may also comprise a start time for the ‘global’ journey. The start time may be obtained by the user entering the start time for the ‘global’ journey (for example, when they are planning a ‘global’ journey for the future), or it may be obtained as the current time (for example, when the start location is the current location of the route guidance module 110 and the ‘global’ journey is to take place immediately) as indicated by the location module 118 or an internal device clock within the route guidance module 110, or by any other suitable means. The start time may comprise a time of day (for example, 22:34) and a date (for example 4 Jan. 2015).

Optionally, the basic journey data may comprise one or more way-points, which may be input by the user. Way-points are locations that the user would like to pass through during their journey, for example a petrol/gas station, or a battery recharge point, or a friend's house, etc.

Optionally, the basic journey data may also comprise a vehicle ID and/or a driver ID. The vehicle ID provides some indication of the vehicle that will be undertaking the journey, for example it may be indicative of the make of the vehicle and/or the model of the vehicle and/or the age of the vehicle and/or a unique identifier of the vehicle itself (such as a Vehicle Identification Number (VIN), or a vehicle license or registration number, etc). The vehicle ID may be obtained by any suitable means, for example it may be read from the memory module 114 (for example, if the user previously stored it in the memory module 114), or it may be entered by the user via a user interface (for example, a list of potential vehicle makes and/or models may be stored in the memory module 114 and then displayed to the user on a display screen of the route guidance module 110 for selection by the user), etc. Optionally, characteristics that are specific to the vehicle (such as typical fuel efficiencies that a particular vehicle actually achieves on the road, etc) may be learned over time and stored in the memory module 114 with an association to the vehicle ID. These characteristics may be then be looked up using the vehicle ID and used, as described in more detail later.

The driver ID may be any value that uniquely identifies the driver that will be driving the vehicle for the duration of the journey. It may be obtained by any suitable means, for example it may be entered by the user via a user interface on the route guidance module 110 (for example, a list of potential drivers may be stored in the memory module 114 and then displayed to the user on a display screen of the route guidance module 110 for selection by the user), or the key-fob used to turn on the vehicle may be driver specific (such that the route guidance module 110 can recognise the driver of the vehicle by scanning the key-fob), by gait analysis of the driver as they approach the vehicle, by heart beat analysis of the driver, by face recognition, etc. Optionally, driver specific characteristics (such as response times to requests to accelerate, decelerate, turn, etc, and/or typical accelerations and/or decelerations and/or typical speeds compared with target speed, etc) may be learned over time and stored in the memory module 114 with an association to the driver ID. These characteristics may be then be looked up using the driver ID and used, as described in more detail later.

The table below is representative of example basic journey data.

| ITEM | VALUE |
|---|---|
| Start location | 51°30′15.7″N 0°0449.6″W |
| Start time | 14.23 17 November 2016 |
| Destination location | 51°31′58.2″N 0°07′28.0″W |
| Waypoints | 51°31′01.1″N 0°04′51.6″W |
| | 51°30′50.5″N 0°05′54.1″W |
| Driver ID | XCY9981 |
| Vehicle ID (VIN number) | 1HGCM82633A004352 |

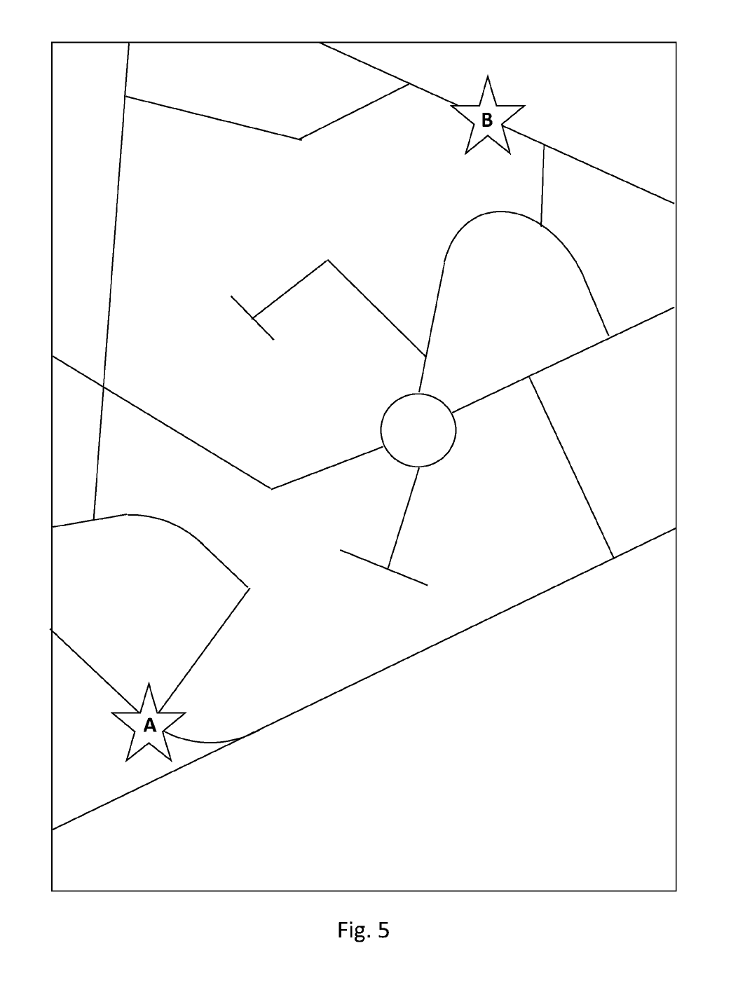

FIG. 5 shows an example road-network, on which is represented a start location A and a destination location B. Optionally, this representation of the road-network may be displayed on a display screen of the route guidance module 110 after the basic journey data has been obtained.

In Step S420, mapping data and optionally traffic data and/or weather data are obtained for the purpose of determining one or more potential routes for a journey from the start location A to the destination location B (optionally via any waypoints identified in the basic journey data). The mapping data, traffic data and weather data obtained may be determined based on the start location A and destination location B in the basic journey data (for example, the mapping data may be limited to a particular geographical area that includes the start location and destination location). Any suitable mapping data may be obtained, for example from locally stored mapping data on the memory module 114, or it may be obtained via the interface 140 from the route guidance server 126, or any other suitable remote location. The mapping data may take the form of a directed graph that represents the layout of the road network and may include various attributes such as traffic rules for the road network (for example, one-way streets, speed limits, etc), altitude and/or gradient information for the road network, the type of roads on the road network (for example, multi-lane motorways or highways, two-way streets, single lane roads, etc), an indication of the road surfaces on the road network (for example “rough”, “smooth”, “concrete”, “tarmac”, “pot-holed”, “bumpy”, etc). Traffic data and/or weather data may also be included in the obtained mapping data, or they may be obtained from the traffic information server 122 via the interface 140 and/or from the weather information server 124 via the interface 140. Any data that is obtained from an external entity (such as mapping data from the route guidance server 126) may additionally be stored in the memory module 114, in case of a future loss of connectivity on the interface 140.

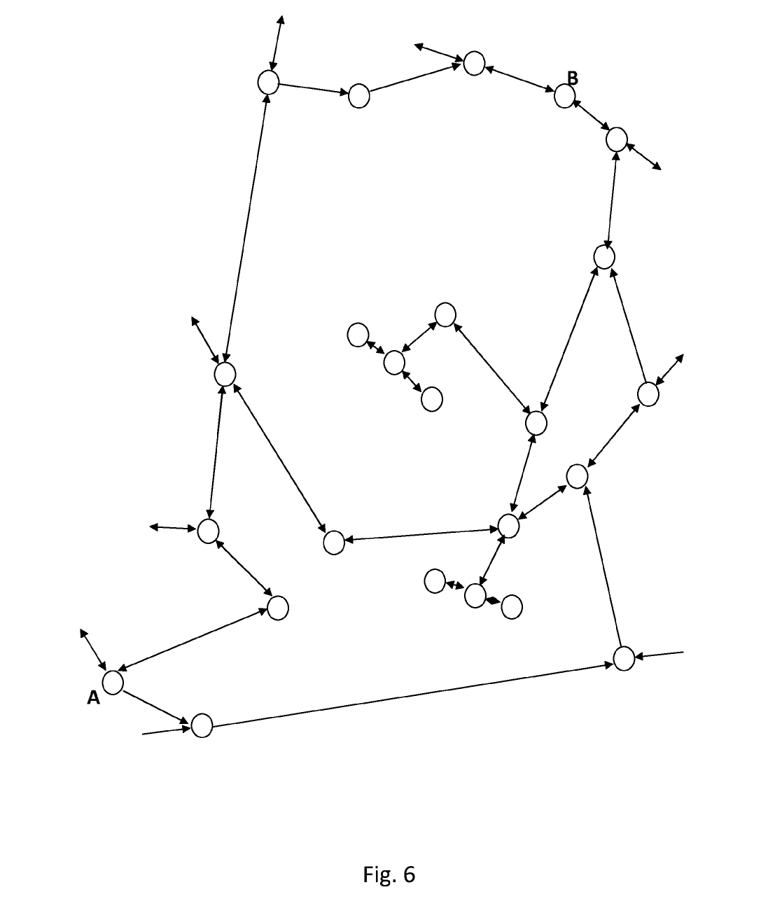

FIG. 6 shows an example representation of a directed graph that is at least part of the mapping data that may be obtained in Step S420. The representation shows a directed graph comprising nodes (sometimes referred to as ‘vertices’), representative of significant points, and interconnecting edges, representative of pathways, the nodes and interconnecting edges together forming a basic representation of the road network. The nodes in the directed graph represent significant points on the road network, for example intersections, junctions, points at which a pathway alters, etc. The interconnecting edges in the directed graph represent roads that connect each of the nodes. One or more (preferably all) of the nodes may have associated attributes, such as its geographical location on the road network (for example, GPS coordinates), its significance on the road network (for example, a junction, intersection, etc), average vehicle waiting times at the node, the altitude of the geographical location represented by the node, etc. One or more (preferably all) of the interconnecting edges may have associated attributes, such as the travelling distance represented by the interconnecting edge, a speed limit, a gradient of the road, a type of road (for example, single lane, duel-carriageway, three-lane highway/motorway, etc), any road laws particular to the stretch of road represented by the edge (for example, one-way street), an indication of the road surface represented by the interconnecting edge, an indication of the curvature of road represented by the interconnecting edge (for example, smallest radius of curvature on the road, etc) etc.

The directed graph represented in FIG. 6 is representative of the road-network of FIG. 5. As can be seen, each of the junctions, roundabouts and significant road direction changes in FIG. 5 is represented with a node in the directed graph of FIG. 6. Optionally, there may also be nodes between intersections and junctions, for example at intervals along a long stretch of road. There may be more nodes in urban and/or complex areas (for example, around complex intersections) and nodes may be further apart where speed limits are higher and/or the road network is less complex.

In Step S430, one or more potential routes may be determined based on the basic journey data (most particularly the start time, start location, destination location and waypoints) and the directed graph and optionally also traffic data and/or weather data using any suitable technique that will be well understood by the skilled person, for example by using a tree search algorithm guided by a heuristic. Each determined route will have an associated estimated journey time and estimated energy consumption for the ‘global’ journey. The estimated journey time may be represented in any suitable form, for example a total travel time in hours and minutes, or an estimated time of arrival at the destination location. The estimated energy consumption may be represented in any suitable form that is indicative of the amount of energy that may be consumed during the journey, for example average fuel consumption (such as miles-per-gallon (mpg), or kilometres-per-litre (kpl), or Watt hours per kilometre (Wh/km), etc) or total fuel consumption for the journey. The estimated journey time and estimated energy consumption may be required for determining a nominal journey understanding (explained below) and need only be very approximate at this stage. It is preferable for the determination of the one or more potential routes to be made to be computationally low cost, which may be achieved by using typical average speeds of driving based on the traffic data and/or the weather data, by using typical average energy efficiencies, and by using generic waiting periods at road intersections. Optionally, the estimated journey time and energy consumption may be determined also in consideration of the driver ID and/or vehicle ID in the basic journey data. For example, information about typical driving speeds and energy efficiencies for the driver may be looked-up from memory module 114, or obtained from the route guidance server 126, using the driver ID and/or information about vehicle energy consumption may be looked-up from memory module 114, or obtained from the route guidance server 126, using the vehicle ID.

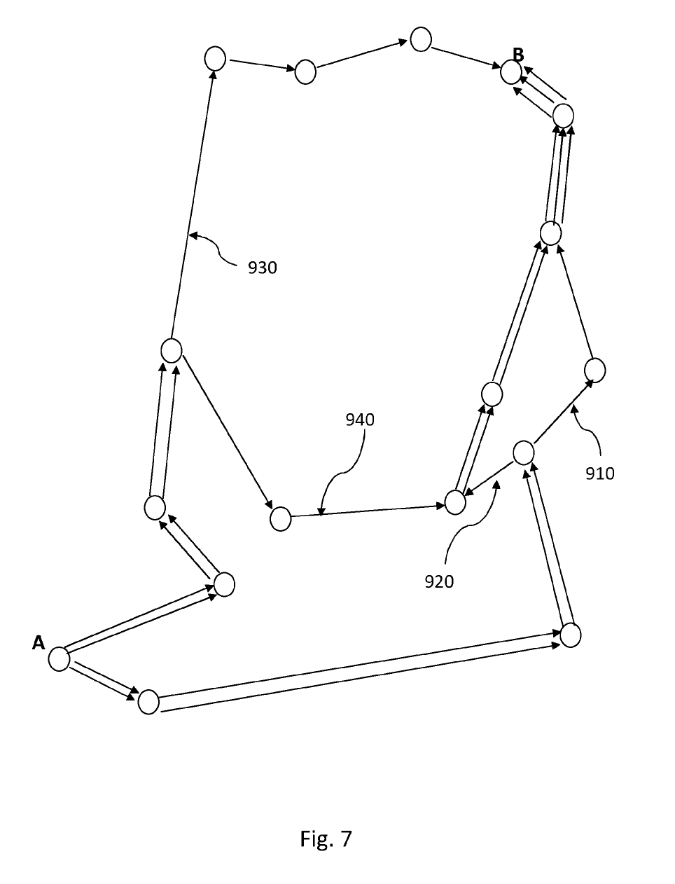

FIG. 7 shows a directed graph representing the potential routes from the start location A to the destination location B. The representation shown in FIG. 7 is a directed acyclic graph (DAG), which is a particular type of directed graph that represents a particular sequences of nodes and edges such that each edge is directed from an earlier node to a later node in sequence. Each potential route is made up from a chain of edges linking nodes that would be travelled through on the route. Each edge shows the direction of travel, and where there are two or more edges connect a pair of nodes, this shows that two or more potential routes utilise a particular edge of the directed graph. Four potential routes are represented: 910, 920, 930 and 940.

In Step S440, having determined the one or more potential routes, a nominal journey understanding is determined based on the one or more potential routes. The nominal journey understanding comprises a nominal journey time and a nominal energy consumption for the ‘global’ journey. Typically, a large number of different potential routes may be determined in Step S430, for example a number between 10 and 100. The number of different potential routes may be dependent on many factors, for example how far apart the start location and destination location are from each other (a greater distance may result in a larger number of potential routes), the complexity of the road network (a very dense road network may result in a larger number of different potential roads), etc. Across all of the different potential routes, there may be a wide range of estimated journey times and estimated energy consumptions. In order to determine a nominal journey understanding, the number of potential routes may be analysed using any suitable statistical technique to determine an average estimated journey time and an average energy consumption. Optionally, outlier routes may be eliminated in Step 240 by any suitable statistical analysis. The nominal journey time may be the average (for example, the mean) of the estimated journey times of the remaining potential routes and the nominal energy consumption may be the average (for example, the mean) of the estimated energy consumptions of those remaining potential routes.

As indicated above, any suitable technique may be used to determine the nominal journey understanding from the potential routes determined in Step S430. However, it may be preferable for the techniques to be computationally low-cost, so that the nominal journey understanding may be determined quickly.

A.2 Obtaining Journey Objectives and Destination Objectives

With a nominal journey understanding, the destination objectives may be obtained. Destination objectives are objectives to be achieved at the end of the ‘global’ journey, on arrival at the destination location. Destination objectives comprise at least one of a punctuality objective and/or an efficiency objective.

The punctuality objective is indicative of the desired arrival time at the destination location. The punctuality objective may comprise a specific desired arrival time at the destination (for example 11:38, or 17:00, or 22:21, etc), ora range (or window) of desired arrival times at the destination (for example 11:30 to 11:50, or 14:55 to 16:10, etc), or a specific desired total journey time from the start location to the end location (for example, 2 hours and 12 minutes, or 30 minutes, or 1 hour and 5 minutes, etc), or a range (or window) of desired total journey times from the start location to the destination location (for example, 1 hour to 1.5 hours, or 20 minutes to 25 minutes, or 4.1 hours to 4.7 hours, etc). Where the punctuality objective comprises a desired total journey time, or desired range of total journey times, it is indicative of the desired arrival time at the destination because the start time of the journey added to the desired total journey time, or desired range of total journey times, gives the desired arrival time.

The efficiency objective is indicative of the desired energy efficiency for the journey from the start location to the destination location. Energy efficiency may be measured in any suitable way, depending on user preference and/or the type of vehicle being used (for example, an electric power vehicle, or a gasoline/diesel powered vehicle, etc). For example, energy may be measured in miles-per-gallon (mpg)/kilometres-per-litre (kpl), or in gallons/litres of fuel, or in Watt hours per kilometre (Wh/km)/Watt hours per mile (Wh/mi), or in Watt hours (Wh) etc. The efficiency objective may comprise a specific desired energy efficiency or energy consumption for the journey (for example, 24 mpg, or 51 mpg, or 12 litres, or 26 litres, or 88 Wh/km, or 143 Wh/km, 876 Wh, or 1550 Wh, etc) or a range of desired energy efficiencies or energy consumptions for the journey (for example, 30-35 mpg, or 8-10 litres, or 100-125 Wh/km, or 250-300 Wh, etc).

The journey objectives are objectives to be achieved during the journey from the start location to the destination location. The journey objectives comprise a comfort objective and/or a legality objective.

The comfort objective is indicative of a desired level of comfort for the duration of the journey, for example “comfortable”, “mid/standard”, or “vigorous”. Comfort may, for example, be assessed by consideration of the acceleration(s) that would be experienced by the driver and passengers within the vehicle. Different accelerations may be assessed using, for example, acceleration in at least one of three different axes of acceleration. For example, the accelerations considered may comprise at least one of: longitudinal acceleration (for example, caused by the vehicle speeding up); longitudinal deceleration (for example, caused by the vehicle slowing down); lateral acceleration rate of change (for example, caused by the vehicle changing direction); acceleration/deceleration rate of change; frequencies of changes in acceleration. Consequently, the comfort indicator may take the form of a maximum allowable level of acceleration for each of one or more different types of acceleration, wherein lower maximums for the allowable levels of acceleration are generally indicative of the higher levels of desired comfort.

The legality objective is indicative of an attitude towards speed limits. The legality objective may comprise an absolute speed value indicative of a desired maximum speed relative to the speed limit (for example, +3 mph, or −8 mph, or +2 kph, or −13 kph), or a relative speed value indicative of a desired maximum percentage of the speed limit (for example 100%, or 95%, or 102%, etc). For example, if the legality objective is set to −3 mph, the maximum allowable speed will be 3 mph below the posted speed limit for each road (for example, on a 30 mph road, the maximum allowable speed would be 27 mph, and for a 50 mph road, the maximum allowable speed would be 47 mph). In a further example, if the legality objective is set to 105%, the maximum allowable speed will be 5% above the posted speed limit for each read (for example, on a 40 kph road, the maximum allowable speed would be 42 kph, and for a 90 kph road, the maximum allowable speed would be 94.5 kph).

The journey objectives and destination objectives may be obtained by the user inputting them to the route guidance module 110. In that case, the journey objectives and destination objectives may be obtained by the route guidance module 110 receiving them from the user.

FIG. 8 shows an example Graphical User Interface (GUI) that may be displayed to the user of the route guidance module 110 (for example, using a display screen or touchscreen on the route guidance module 110) to prompt the user to input their journey objectives and destination objectives. The user may enter their desired journey objectives and destination objectives by adjusting the sliders represented in FIG. 8, for example using a touch screen, or by any other suitable means, such as a mouse or push buttons, etc.

The punctuality objective 810 may be set based on the nominal journey time, which in this example is a nominal arrival time of 15:02. A lower limit for the punctuality objective may be set by adjusting the slider to the left of the nominal arrival time. In this example, the lower limit is set to the lowest allowable time, which is 15:00. An upper limit for the punctuality objective may be set by adjusting the slider to the right of the nominal arrival time. In this example, the upper limit is set to the highest allowable time, which is 15:09. Thus, the punctuality objective in this example is set to 15:00-15:09. It will be appreciated that the allowable upper and lower limits that may be set by the user can be constrained to values wherein the punctuality objective is likely to be achievable. This can prevent a situation where the nominal journey time is 3 hours, but the user enters an unrealistic and unachievable punctuality objective of 1 hour. The values to which the punctuality objective is constrained may be determined in any suitable way, for example in consideration of the nominal journey time and/or the spread of the different estimated journey times identified in Step S430 of FIG. 4 explained above.

The efficiency objective 830 may be set based on the nominal energy consumption, which in this particular instance is 51.4 mpg. If the user desires a higher efficiency, they may move the slider to the right towards “higher rate”, and if they would be satisfied with a lower efficiency, they may move the slider to the left towards “lower rate”. In this example, the efficiency objective 830 is set to the nominal energy consumption, 51.4 mpg. This may be understood to be the minimum level of efficiency that the user desires for the journey, or a specific value that they wish to achieve for the journey. Again, it will be appreciated that maximal and minimal values that may be set by the user can be constrained to values wherein the efficiency objective is likely to be achievable. The values to which the efficiency objective may be constrained may be determined in any suitable way, for example in consideration of the nominal energy consumption and/or the spread of the different estimated energy consumptions identified in Step S430 of FIG. 4 explained above.

The comfort objective 820 can be continuously set by the user to any point on the range from “comfortable” to “vigorous”, with “mid/standard” in the middle. In the example represented in FIG. 8, the comfort objective 820 is set to “mid/standard”, which has an associated set of maximum allowable acceleration values for the journey of: LatAcc (Lateral Acceleration): 0.25 ms⁻², LngAcc (Longitudinal Acceleration): 0.25 ms⁻²; LngDec (Longitudinal Deceleration): 0.2 ms⁻²; LatJerkAcc (Lateral acceleration rate of change): 0.2 ms⁻³; LngJerkAcc (Longitudinal acceleration rate of change): 0.2 ms⁻³; LngJerkDec (Longitudinal deceleration rate of change): 0.17 ms⁻³. Additionally, or alternatively, any other kinematic measurements that may help to quantify the comfort levels of a journey in a vehicle may be set to indicate the desire comfort for the journey. For example, some frequencies of changes in acceleration are understood to cause travel sickness, so the comfort objective may also set a particular frequency, or frequencies, of acceleration/deceleration changes that should be avoided. As the user slides the slider towards “comfortable” or “vigorous”, at least one of the values of maximum allowable acceleration values will change to reflect the change in the user's desired level of comfort. The maximum allowable values for different levels of desired comfort may be set in any suitable way, for example they may be based upon known handling characteristics for particular vehicles (which may be understood using the vehicle ID), or on default values that are understood to driver and passenger responses to particular levels of acceleration/deceleration, etc. The specific values of the different acceleration/deceleration parameters may adjust with changes to the users indicated desired level of comfort in any suitable way, for example by referring to a look-up table (for example, stored in the memory module 114), or using mathematical formulae, etc.

The legality objective 840 can be continuously set by the user between limits. In the example represented in FIG. 8, it may be set to any value between −10% (i.e., a maximum speed on any road in the journey being set to 10% below the speed limit) and +5% (i.e., a maximum speed on any road in the journey being set to 5% above the speed limit). In the example represented in FIG. 8, the legality objective 840 is set to 0%, indicating that the speed limit on any road may be reached, but not exceeded.

Optionally, the value to which the user may set the comfort objective 820 and/or the legality objective 840 may be adjusted in consideration of traffic data and/or weather data. For example, if high levels of traffic and/or poor weather conditions such as rain or snow are expected, the constraint for the comfort objective 820 and/or legality objective 840 may be shifted down. In this way, safety for the vehicle and its occupants may be improved and more realistic journey objectives be set.

In some cases, ranges of objectives presented to the user are all compatible, such that the user cannot set one of the objectives to a value that causes a different objective no longer to be achievable (for example, the legality objective cannot be set to such a low value that the range of punctuality objectives is no longer achievable). In other cases, some combinations of objectives may be mutually exclusive, so that the selection of certain objectives will limit the range of choice in other objectives. For example, choosing an early arrival time at the destination may mean that high levels of comfort and energy efficiency cannot be achieved. In this case, the selection of certain objectives by the user may cause the range of values for other objectives to change, or for certain options for objectives to be greyed out. If the user has already chosen an objective that later becomes out of range after the user chooses another objective, the user interface may highlight the objective which is now out of range and offer the user a suitable compromise, or may modify the objective that is out of range to the nearest value that is within the allowable range.

It will be appreciated that the ‘sliders’ example shown in FIG. 8 is merely one non-limiting example implementation of obtaining the journey objectives and destination objectives from the user. Any other suitable implementations may alternatively be used, for example the user may be presented with a set of discrete option boxes for some or all of the objectives, or may be presented with a data input box for some or all of the objectives wherein they may input an indication of the objective(s) (optionally within displayed allowable constraints for the objective(s)).

The table below is representative of the example objectives set by the user in FIG. 8.

| OBJECTIVE | VALUE |
|---|---|
| Efficiency objective | At least 51.4 mpg |
| Punctuality objective | 15:00-15:09 18 December 2016 |
| Comfort objective | LatAcc: 0.25 ms⁻², LngAcc: 0.25 ms⁻²; |
| | LngDec 0.2 ms⁻²; LatJerkAcc: |
| | 0.2 ms⁻³; LngJerkAcc: 0.2 ms⁻³; |
| | LngJerkDec: 0.17 ms⁻³ |
| Legality objective | 0% |

In an alternative implementation, any one or more of the destination objectives and/or journey objectives may be obtained in a different way (i.e., not from the user). For example, one or more of the destination objectives and/or journey objectives may be set to a default value that cannot be altered by the user. In one particular example, the comfort objective may be set to a fixed “comfort” setting, for example where the route guidance module 110 is tied to a luxury vehicle and the vehicle manufacturer wishes for all journeys to be conducted in the most comfortable way. In a further example, the route guidance module 110 may be used in a commercial context (for example, for use in the course of deliveries, or for taxi journeys, etc) and the company may stipulate that the efficiency objective is set to a fixed “economy” setting in order to minimise fuel costs and/or the legality objective may be set to a fixed level just below the speed limit, to improve safety and ensure that their vehicles do not gain a bad reputation on the roads.

In these instances, the one or more destination objectives and/or journey objectives may not be obtained from a user input, or may be obtained from the memory module 114 (for example, looking up the fixed value to which the objective is set), or from an external entity, such as the route guidance server 126, or a commercial company server (such as a taxi dispatch server), via the interface 140.

A.3 Development of a Directed Graph of Routing Options

Having obtained the destination objectives and journey objectives, a directed graph of routing options may be developed based on the potential routes determined in Step S430 of part A.1 described above.

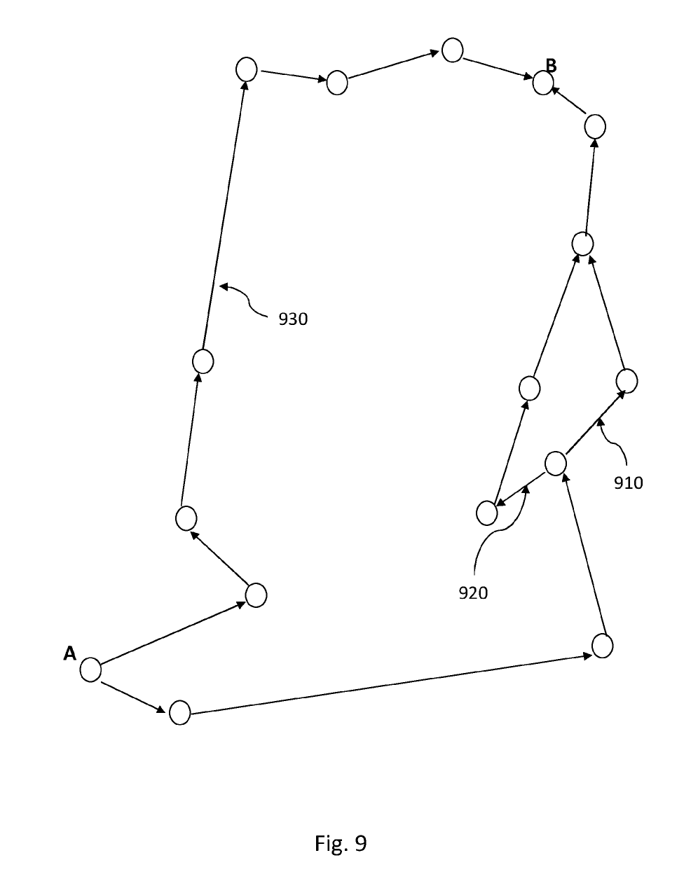

FIG. 9 shows an example directed graph of routing options. The directed graph of routing options may be developed by starting with the potential routes determined in Step S430 of part A.1 (i.e., starting with the potential routes represented in FIG. 7) and then optionally eliminating any potential routes that fail to meet the destination objectives (or fail to fall within a tolerance of the destination objectives). For example, the efficiency objective may specify a particular minimum efficiency (for example, 51.4 mpg) and one of the potential routes may estimate an energy consumption of 40 mpg. Likewise, the punctuality objective may indicate an arrival time window of 13:30-14:00, and a number of the potential routes may estimate an arrival time of 14:45 or later. The directed graph of routing options represented in FIG. 9 is based on that of FIG. 7, but eliminates duplicate arrows on edges, such that all edges that form part of at least one route are represented with only one arrow. Route 940 is also not included in FIG. 9, to represent an example whereby route 940 has been eliminated during the development of the directed graph of routing options as it resulted in an estimated arrival time at location B and/or an estimated energy consumption for the journey that exceeded the destination objectives.

By developing the directed graph of routing options in this way, the size and extent of the directed graph of routing options may be reduced from the potential routes determined in Step S430, thereby improving computational efficiency when the directed graph of routing options is used in the future.

If confidence is low that one or many of the objectives can be met (for example, none of the routes in the directed graph of routing options are expected to meet one or more of the objectives, or the directed graph of routing options comprises an insufficient number of potential routes that should meet some or all of the objectives with sufficient certainty to satisfy a confidence threshold), the process may proceed to part A.4.

In part A.4, the user may be informed that confidence in meeting the objectives is low (for example, by displaying a warning message on the screen), at which time the process may return to part A.2 where the user may adjust one or more of the objectives to improve confidence. Alternatively, the user may indicate that they wish to proceed anyway, in which case the process proceeds to completion of the journey definition.

It will be appreciated that assessment of confidence and part A.4 are optional. In one alternative implementation, if confidence is low, an error message may be displayed to the user and the process of determining the journey definition started again. In another alternative, confidence may not be assessed and the process may always proceed from Step A.3 to the journey definition.

Having developed the directed graph of routing options, the journey definition comprising the basic journey details, the destination objectives and journey objectives, and the directed graph of routing options is completed and may be passed on to part B—“determination of ‘global’ journey policy”.

It will be appreciated that the steps A.1-A.3 represented in FIG. 3 represent only one way in which the journey definition may be determined and that there may be many alternatives to these steps.

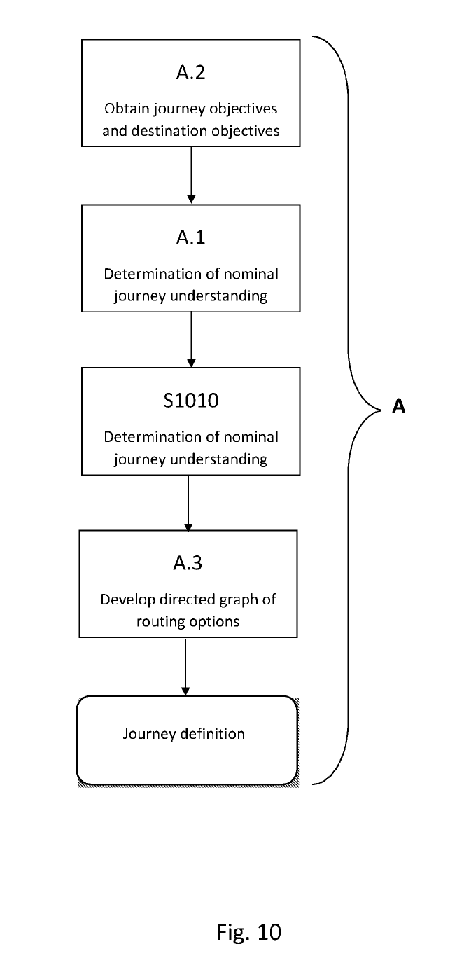

By way of example, FIG. 10 shows an alternative implementation, whereby the destination objectives and journey objectives are obtained in part A.2 first.

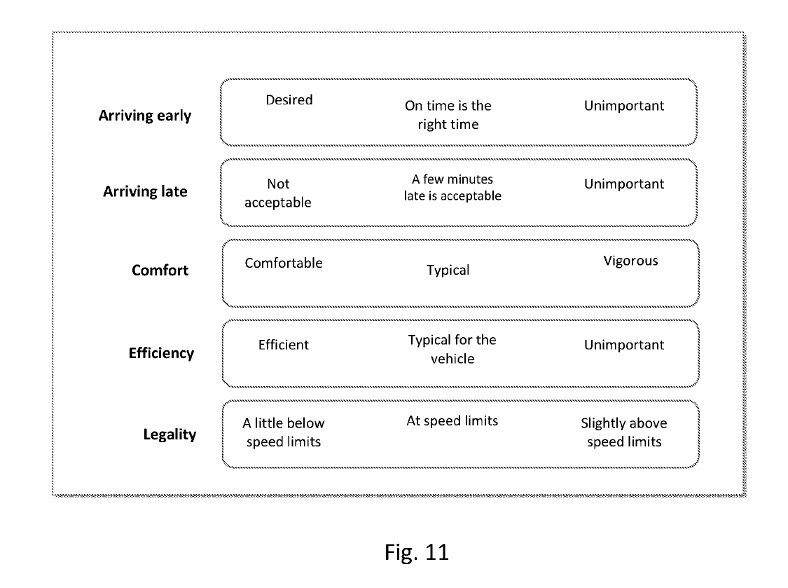

FIG. 11 shows an example representation of a graphical user interface (GUI) that may be displayed to the user (for example, via a display screen in the route guidance module 110) in order to obtain the objectives. In this example, the user is presented with a set of discrete option boxes for each objective and the objectives are obtained by receiving them from the user via their selection of options for the objectives.

For the punctuality objective 810, the user may indicate if, relative to a nominal journey time (which is to be determined later in step A.1), they would like to arrive early (“desired”, “on time is the right time” or “unimportant”) and whether they would accept being late (“not acceptable”, “a few minutes late is acceptable”, or “unimportant”). It will be appreciated, therefore, that in this implementation, the punctuality objective is more general than in the example described earlier, because the user does not know the nominal journey time when setting the punctuality objective—they instead merely indicate their general attitude towards punctuality for the journey.

For the comfort objective 820, the user may indicate that they would like the ride to be “comfortable”, “typical” or “vigorous”, without any opportunity to set a level of comfort between those options.

For the efficiency objective 830, the user may indicate what level of efficiency, relative to a nominal energy consumption (which is to be determined later in step A.3), they would like to achieve. In this example, they may set “efficient”, “typical for the vehicle” or “unimportant”. Again, it will be appreciated that in this implementation, the efficiency objective is more general than in the example described earlier, because the user does not know the nominal energy consumption for the journey when setting the efficiency objective—they instead merely indicate their general attitude towards efficiency for the journey.

Finally, for the legality objective 840, the user may indicate that, at most, they would like to drive “a little below speed limits”, “at speed limits” or “slightly above speed limits”.

Three options are presented to the user for each of the objectives. However, more, or fewer, options may alternatively be presented to the user for each of the objectives. Furthermore, one or more of the objectives may be set using a slide bar, as described earlier in respect of FIG. 8, or by any other means.

Additionally, or alternatively, one or more of the objectives may be set as default objectives by the user or by anyone else, such as the vehicle manufacturer (for example, the user may set a default level of efficiency that they would like to use for all journeys) and the objective may be obtained by looking it up in memory module 114, or obtaining it from the route guidance server 126 via the interface 140, or obtaining it from any other external entity.

Having obtained the objectives, the process may then proceed to part A.1, where a nominal journey understanding is obtained, as described earlier. Having developed a nominal journey understanding, the process may optionally proceed to Step S1010, where the user is given the opportunity to adjust one or more of the objectives in consideration of the nominal journey understanding (for example, in consideration of the nominal journey time and/or the nominal energy consumption). However, Step S1010 is merely optional, and in some implementations, the process may proceed from Step A.1 to A.3.

In Step A.3, a directed graph of routing options is developed, as described earlier.

Whilst it is preferable to perform the process steps described with reference to FIGS. 4 and 10 (for example, so that the directed graph of routing options may have a large number of routing options), in a further alternative implementation of the determination of a journey definition (part A), the journey objectives and destination objectives may be obtained at any time and steps A.1 and/or A.3 may be omitted. For example, the directed graph of routing options and nominal journey understanding may simply be that provided by an existing navigation service. The start location and destination location may be obtained in any way described above in respect of Step S410 and then provided to an existing navigation API. The directed graph of routing options may then simply be the one or more routing options (for example, three routing options) returned by the navigation API. The nominal journey time and nominal energy consumption may be the estimated arrival time and energy consumption provided by the navigation API. The journey definition may then comprise those data obtained from the navigation API and the objectives obtained in Step A.2.

B Determination of ‘Global’ Journey Policy

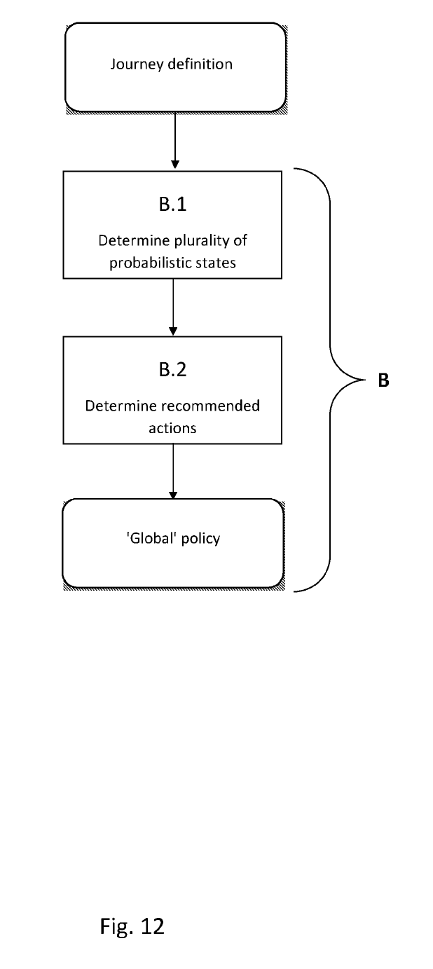

FIG. 12 shows a representation of example process steps for the determination of a ‘global’ journey policy. The term ‘global’ is used in the present disclosure to indicate that the ‘global’ journey policy is for the entire journey from the start location to the end location (i.e., from A to B in FIG. 5). The journey definition from part A is fed to part B for determining the ‘global’ journey policy. Determining the ‘global’ journey policy comprises determining a plurality of probabilistic states (part B.1) and determining recommended actions (part B.2).

The steps used for determining the ‘global’ journey policy may also be used for determining a ‘local’ journey policy, as is explained in more detail later in this disclosure.

B.1 Determining a Plurality of Probabilistic States

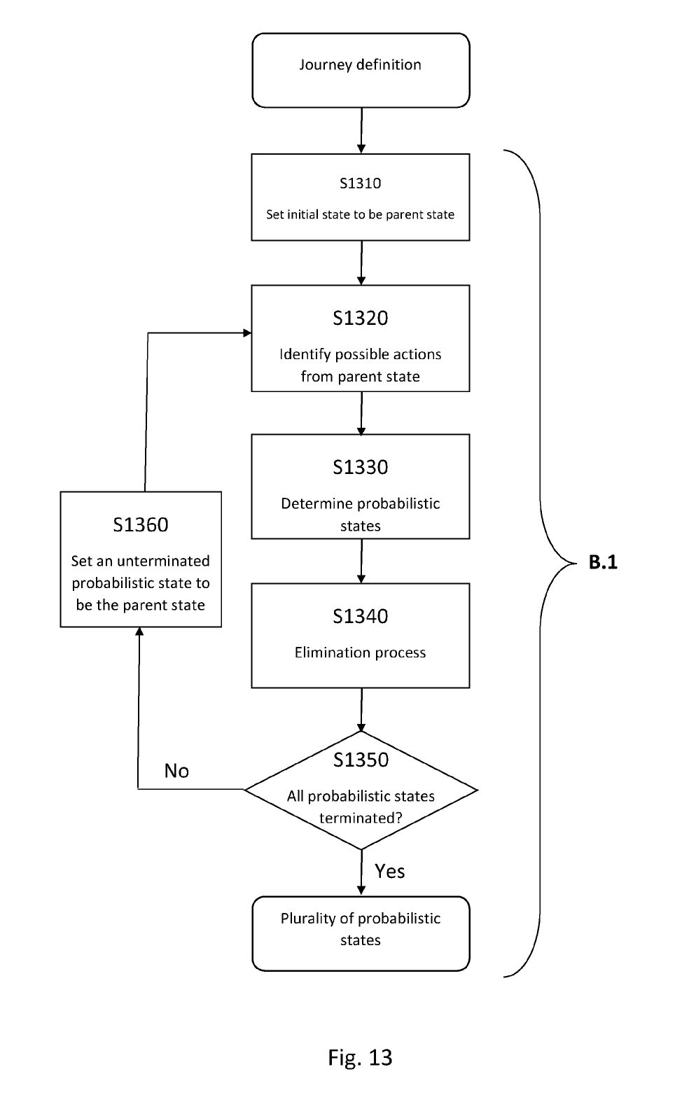

FIG. 13 shows a representation of example process steps explaining how a plurality of probabilistic states may be determined. In one particular example, the plurality of probabilistic states may be determined as a sequential decision problem, such as a probabilistic sequential decision problem. Examples of probabilistic sequential decision problems are a Markov Decision Process (MDP) (described here: http://en.wikipedia.org/wiki/Markov_decision_process), a semi-Markov Decision Process and an Interval Markov Decision Process. In the following, a Markov Decision Process (MDP) comprising the plurality of probabilistic states is described. However, it will be appreciated that the plurality of probabilistic states may alternatively make up any other suitable type of sequential decision process, such as variants on an MDP.

The skilled person will understand that an MDP is a framework for modelling decision making where outcomes are partly random and partly under the control of a decision maker, as described here: https://en.wikipedia.org/wiki/Markov_decision_process. In the present scenario, the arrival time at the destination B and the energy consumption to get to destination B is partly random (depending on traffic conditions, waiting time at junctions/traffic lights, speed at which other road users may travel, etc. none of which can be predicted with complete accuracy) and partly under the control of the decision maker (for example, deciding to turn left at a junction rather than right may affect arrival time and/or energy consumption, or deciding to drive more quickly or more slow may affect arrival time and/or energy consumption, etc).

In Step S1310, an initial state is set to be the parent state, and the initial state is based at least in part on the journey definition. The initial state comprises the initial geographical location for the journey (for example, the start location A) and a progress metric for the journey so far. The progress metric in this example comprises a time metric for the journey so far and an efficiency metric for the journey so far. The format for the time metric and the efficiency metric may depend on the format of the punctuality objective and the efficiency objective in the journey definition. For example, if the punctuality objective is a window of desired total journey times (for example, 2 hours to 2.5 hours), the time metric may be the total time for the journey so far. If the punctuality objective is a particular desired arrival time at the destination location (for example, 15:40), the time metric may be a time value (for example, 14:00). Likewise, if the efficiency objective is a desired minimum mpg, the efficiency metric may be the mpg for the journey so far, or if the efficiency objective is a total amount of fuel allowable for the journey (for example, a fuel allowance for the journey), such as 100 litres of diesel, the efficiency metric may be an amount of fuel used for the journey so far, etc.

Since the journey has not yet begun, the time metric for the initial state may be set to 0:00 (if the punctuality objective is the total time for the journey) or to the start time for the journey, for example, the current time, (if the punctuality objective is the desired time of arrival at the destination location). Likewise, the efficiency metric may be set to 0.0 for the initial state.

The initial state may be visualised as follows:
Initial state=[Initial geographical location, time metric, efficiency metric]

Each of the items in the initial state, “initial geographical location”, “time metric” and “efficiency metric” may be thought of as a dimension or parameter of the initial state.

For the example basic journey data identified in part A.1 above and destination objectives represented in FIG. 8 and described in part A.2 above, the initial state may be set in Step S1310 to be:
Initial state=[node A, 14:43, 0 mpg]

The reference ‘Node A’ may be associated with the coordinates of the start location, for example ‘51° 30′15.7″N 0° 0449.6″W’ as identified in the basic journey data. The initial state for the ‘global’ journey policy is therefore representative of the state at the start node A of the directed graph of routing options.

In Step S1320, the possible actions that may be taken from the parent state are identified. The possible actions comprise a possible route action and/or a possible speed action. The possible actions may depend at least in part on the node of the directed graph of routing options identified in the parent state. For example, in the directed graph of routing options represented in FIG. 9, there are two possible choices of direction from node A (represented by two different interconnecting edges emanating from node A). Therefore, when at node A, the driver of the vehicle may be faced with a choice of turning left or turning right, and will therefore require navigation guidance at this time from the route guidance system 110. Consequently, in this example, the possible route action comprises “left” and “right”. It will be appreciated that for other nodes, there may only be one possible route action (for example, where the node corresponds to a simple change in direction of a road, or is an intermediate node set on a long, straight road, etc), in which case the possible route action would comprise only “continue”. For other nodes, there may be three or more possible route actions (for example where the node corresponds to a crossroads or a roundabout where the driver could choose to go in three or more different directions), in which case the possible route action would comprise each of the possible directions that the driver would have to choose between at that node (and will therefore require guidance on from the route guidance module 110).

The possible speed action may comprise one or more different speeds at which the driver could travel on the road. The number of different speeds identified in Step S1320 may depend on the particular configuration of the route guidance module 110, where in general a larger number of different speeds may result in a superior journey guidance policy, but at the expense of increased computational overhead. In this example, the possible speed action comprises three possible speeds: fast; medium and slow, although any number of possible speed actions could be identified. The values of fast, medium and slow may be set in any suitable way, for example in consideration of one or more of: the legality objective; the speed limit for the road that will be travelled; the type of road (for example, a multilane highway or motorway may allow a larger range of possible speeds, as slower traffic can occupy the inside lane, etc), weather data; and/or traffic data. For example, the speed limit for the road may be 40 mph and the legality objective may indicate that speeds of up to 5% over the speed limit are allowable. In this case, the value of the speed action for ‘fast’ may be set to 42 mph, the value of the speed action for ‘medium’ to 38 mph and the value of the speed action for ‘slow’ to 34 mph. Likewise, if the traffic data predicts heavy traffic on the road and/or the weather data predicts rain on the road at the time the vehicle will be travelling along it, values for the ‘fast’, ‘medium’ and ‘slow’ speed actions may be lowered.

The identified possible actions may be visualised for the purposes of this disclosure as follows:

| POSSIBLE ROUTE ACTION | POSSIBLE SPEED ACTION |
|---|---|
| Left | Fast |
| Left | Medium |
| Left | Slow |
| Right | Fast |
| Right | Medium |
| Right | Slow |

It will be appreciated that the road on which the vehicle would travel if a left turn is made may have different attributes affecting potential speeds (for example, a different speed limit, weather conditions, traffic conditions, etc) to the road on which the vehicle would travel if a right turn is made. Therefore, the values for ‘fast’, ‘medium’ and ‘slow’ may be different for the left turn compared with the values for the right turn.

Furthermore, the values for ‘fast’, ‘medium’ and ‘slow’ may also be set in consideration of the comfort objective. For example, based on knowledge of the road (for example, elevation changes, direction changes, road surface, etc), which may be attributes associated with the directed graph of routing options, it may be determined whether or not anticipated accelerations might exceed the maximum allowable accelerations set by the comfort objective. Consequently, the values for the possible speed actions may be set so that for each possible speed action, the legality objective and the comfort objective are respected.

Based on the example directed graph of routing options represented in FIG. 9, we will assume that the directed graph of routing options indicates that the road that would be travelled with a left turn (i.e., the longer of the interconnecting edges emanating from node A) has a 30 mph speed limit and the road that would be travelled with a right turn (i.e., the shorter of the interconnecting edges emanating from node A) has a 50 mph speed limit. In the journey objectives represented in FIG. 8 and explained earlier in respect of step A.2, the legality objective is set to 0% (i.e., maximum allowable speed is the speed limit of the road) and the comfort objective is set to “average”. In this particular example, the possible actions may be as follows:

| POSSIBLE ROUTE ACTION | POSSIBLE SPEED ACTION |
|---|---|
| Left | 30 mph |
| Left | 28 mph |
| Left | 26 mph |
| Right | 50 mph |
| Right | 45 mph |
| Right | 40 mph |

Each different combination of possible route action and possible speed action is treated as a possible action, such that each row represented above corresponds to a particular possible action. Thus, at node A, six possible actions are identified.

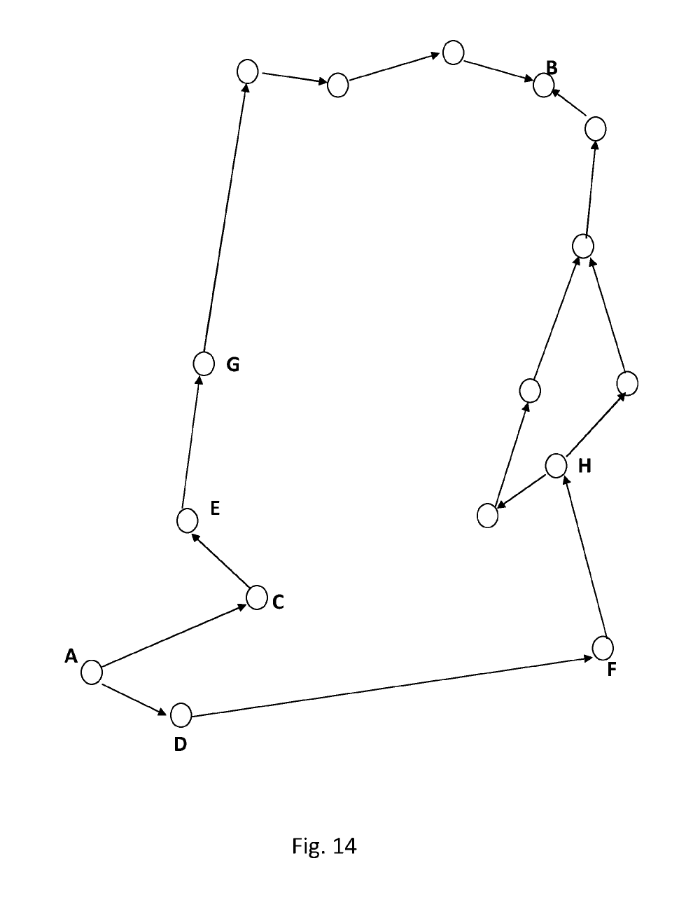

In Step S1330, a plurality of probabilistic states are determined. Probabilistic states are similar to the initial state and comprises a geographical location and a progress metric. The progress metric comprises a time metric for the journey up to the geographical location and/or an efficiency metric for the journey up to the geographical location. Each probabilistic state is associated with a probability of it occurring during the journey. The term ‘probabilistic progress metric’ is used throughout this disclosure to indicate a progress metric that has a probability of happening in the future. The probabilistic state represents a possible future state in which the vehicle may find itself during the journey. FIG. 14 shows an example directed graph of routing options that is based on the directed graph of routing options represented in FIG. 9, but with nodes C and D also identified. Node C is the next node that the vehicle would reach if the possible route action of ‘left’ is taken and node D is the next node that the vehicle would reach if the possible route action of ‘right’ is taken. Each probabilistic state identified in Step S1330 comprises a probabilistic progress metric for the vehicle when it arrives at the next node (i.e., at node C or node D). The time that it might take to travel down a road from node A to C, or A to D, and/or the efficiency of travelling down a road from node A to C, or A to D, cannot be predicted deterministically. That is to say, because road networks are an unconstrained environment, for the same inputs (i.e., travelling down the same road, at the same time of day, in the same vehicle, at the same intended speed, in the same predicted weather conditions, in the same predicted traffic conditions, etc), the outcome (i.e., the time it takes to reach node C or node D and/or the energy efficiency of reaching node C or node D) will not be the same every time. For example, various events may occur when travelling from A to C, or from A to D, that could affect how long it takes and/or the energy efficiency. For example, the traffic conditions could change in any number of different ways, the weather conditions could change, a pedestrian could step out in front of the vehicle thereby slowing it down, traffic signals could work in favour of the vehicle's progress, or against the vehicle's progress, etc, etc.

Consequently, the time and/or efficiency progress of the vehicle when it arrives at node C or node D cannot be predicted with certainty. Thus, in Step S1330, probabilistic states are determined.

The probabilistic states may be better understood by considering the table below:

| POSSIBLE | | | | | |
|---|---|---|---|---|---|
| ACTIONS | | RESULTING PROBABILISTIC STATE | | | |
| | Possible | | Probabilistic progress metric | | |
| Possible | Speed | Geographical | Time | Efficiency | |
| Route Action | Action | Location | Metric | Metric | Probability |
| Left | Fast | Node C | T_{C1} | E_{C1} | P_{C1} |
| | | Node C | T_{C2} | E_{C1} | P_{C2} |
| | | Node C | T_{C1} | E_{C2} | P_{C3} |
| | | Node C | T_{C2} | E_{C2} | P_{C4} |
| Left | Medium | Node C | T_{C3} | E_{C3} | P_{C5} |
| | | Node C | T_{C4} | E_{C3} | P_{C6} |
| | | Node C | T_{C3} | E_{C4} | P_{C7} |
| | | Node C | T_{C4} | E_{C4} | P_{C8} |
| Left | Slow | Node C | T_{C5} | E_{C5} | P_{C9} |
| | | Node C | T_{C6} | E_{C5} | P_{C10} |
| | | Node C | T_{C5} | E_{C6} | P_{C11} |
| | | Node C | T_{C6} | E_{C6} | P_{C12} |
| Right | Fast | Node D | T_{D1} | E_{D1} | P_{D1} |
| | | Node D | T_{D2} | E_{D1} | P_{D2} |
| | | Node D | T_{D1} | E_{D2} | P_{D3} |
| | | Node D | T_{D2} | E_{D2} | P_{D4} |
| Right | Medium | Node D | T_{D3} | E_{D3} | P_{D5} |
| | | Node D | T_{D4} | E_{D3} | P_{D6} |
| | | Node D | T_{D3} | E_{D4} | P_{D7} |
| | | Node D | T_{D4} | E_{D4} | P_{D8} |
| Right | Slow | Node D | T_{D5} | E_{D5} | P_{D9} |
| | | Node D | T_{D6} | E_{D5} | P_{D10} |
| | | Node D | T_{D5} | E_{D6} | P_{D11} |
| | | Node D | T_{D6} | E_{D6} | P_{D12} |

The two different values T_{C1} and T_{C2} of the time metric are two different times, each of which has a probability of happening, at which the vehicle may arrive at node C if the vehicle travels at the ‘fast’ speed. The two different values E_{D1} and E_{D2} of the efficiency metric are two levels of energy, each of which has a probability of happening, that may be consumed to travel to node C. In this example, four different probabilistic states are determined for each of the possible actions identified in Step S1320. These probabilistic states may be understood by considering the following:
Probabilistic state=[Geographical location, Probabilistic progress metric]
Probabilistic state=[Geographical location, Time metric, Efficiency metric, Probability]
State 1=[Node C, T_{C1}, E_{C1}, P_{C1}]
State 2=[Node C, T_{C2}, E_{C1}, P_{C2}]
State 3=[Node C, T_{C1}, E_{C2} P_{C3}]
State 4=[Node C, T_{C2}, E_{C2}, P_{C4}]

The geographical location in each probabilistic state may indicate a geographical location of a node in the directed graph of routing options in any suitable way. For example, it may identify the node to which it relates, with the identified node being associated (for example, in the directed graph of routing options) with GPS coordinates for the geographical location of the node).

Any number of different values for the time metric and/or efficiency metric may be determined for each possible action, for example one, two, three, four, etc. The number of time metric and/or efficiency metric values may be set by the configuration of the route guidance module 110, with a larger number generally resulting in more robust route guidance, but at the cost of increased computational overhead.

Each of the probabilities may take any suitable form, for example a value between 0 and 1, wherein 0 is indicative of a 0% chance and 1 being indicative of a 100% chance. The probabilities for each possible action should sum to 1. For example, P_{C1}+P_{C2}+P_{C3}+P_{C4=1}, P_{C5}+P_{C6}+P_{C7}+P_{C8}=1, P_{C9}+P_{C10}+P_{C11}+P_{C12}=1.

The probability P of each combination of values of time metric and/or efficiency metric occurring as a result of each possible action may be determined in any suitable way. For example, it may be based at least in part on the distance to be travelled to the next node, the value of the possible speed action, traffic data that is relevant for the interconnecting edge that would be traversed, weather data that is relevant for the interconnecting edge that would be traversed, vehicle information such as acceleration and braking capabilities (which may be obtained, for example, using the vehicle ID), driver information such as usual acceleration and braking habits (which may be obtained, for example, using the driver ID), etc. Each of the values of time metric may be indicative of a different possible time of arrival at node C and each of the values of efficiency metric may be indicative of a different possible energy usage to arrive at node C, with each value of probability indicating the likelihood of each combination of time metric value and efficiency metric value occurring.

By way of example, the traffic data and/or weather data may predict particular conditions for the interconnecting edge from node A to node C, or from node A to node D, with degrees of certainty. Based on this, different possible values of time metrics and efficiency metrics may be determined, with each pair of time and efficiency metrics having a probability of occurring that is linked to the degrees of certainty of predicted traffic and/or weather conditions (for example, an 80% chance of high traffic may result in the pairing of a slower value time metric (e.g. T_{C1}) and lower value efficiency metric (e.g., E_{C1}) having a greater associated probability (P_{C1}) than the probability (P_{C4}) associated with the pairing of a faster value time metric (e.g., T_{C2}) and higher value efficiency metric (e.g. E_{C2}). It can be appreciated from the table above that in this particular example, 24 different probabilistic states are determined, with four different probabilistic states (the probabilities in which should add up to 1) being associated with each possible action. There are 12 probabilistic states identifying the geographic location of node C and 12 identifying the geographic location of node D.

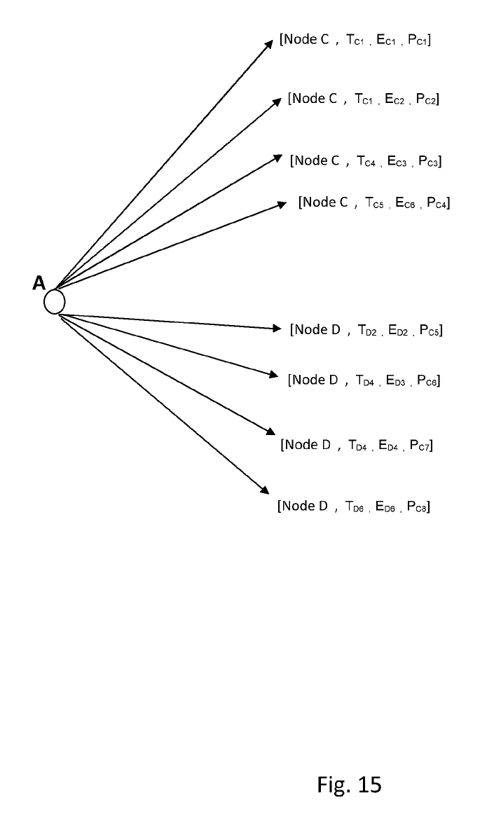

FIG. 15 shows a representation of a Markov Decision Process (MDP) to help visualise the probabilistic states determined in Step S1330.

For the sake of clarity, the MDP in FIG. 15 shows only eight of the determined probabilistic states, four identifying the geographical location node C and four identifying the geographical location node D. The probability included in each probabilistic state (explained above) is indicative of the probability that the probabilistic state at the end of the arrow will be reached if the corresponding possible action is taken from node A.

Having determined a plurality of probabilistic states in Step S1330, in Step S1340 an elimination process is performed, wherein the determined probabilistic states are assessed against the end objective (i.e., the destination objectives when determining the ‘global’ journey policy). Assessment against the end objective may help to remove, or “prune”, probabilistic states from the MDP. Preferably, the elimination process is performed during the determination of the plurality of probabilistic states (for example, as the MDP is being constructed), although in an alternative it may be performed after all of the probabilistic states have been determined (for example, once the MDP is complete). As will become particularly apparent later in the description, performing the elimination process during the determination of the plurality of probabilistic states may significantly reduce computational overheads.

In order to assess each of the probabilistic states determined in Step S1340, a heuristic algorithm may be used. The heuristic algorithm may select a probabilistic state and assess the value of the time metric and/or the efficiency metric in the probabilistic state by considering whether the end objective could be met from the probabilistic state. This may be done in consideration of a best case progress from the node identified in the probabilistic state. For example, the value of the time metric could be assessed by consider a best case time to arrive at the end of the journey (for example, to the destination location when determining the ‘global’ journey policy). The best case time might be the time it takes to travel the remainder of the journey if the vehicle were to travel at the speed limit, or at the maximum speed limit allowable according to the legality objective, or some speed a particular tolerance above either of those values (for example, 10% higher), on each of the remaining edges of the journey. For example, from the ‘global’ journey from node C in FIG. 14, the best case time may be how long it would take to travel along all of the edges between node C and node B, assuming that the vehicle travels at the speed limit on each of the edges. If the value of the time metric in the selected probabilistic state plus the best case time would exceed the punctuality objective, it can be assumed that the punctuality objective cannot be met from that probabilistic state, and that probabilistic state may therefore eliminated from the plurality of probabilistic states (for example, eliminated from the MDP). Additionally, or alternatively, a worst case progress may be considered. For example, a worst case time may be considered, which is the time is may take to travel the remainder of the journey if the vehicle were travelling at a minimum speed (for example, some amount below the speed limit on each road, such as a value between 60-85%, such as 70%, or 75%, 80%). If the value of the time metric in the probabilistic state plus the worst case time is less than the punctuality objective, it can be assumed that arrival would be too early, thereby failing to achieve the punctuality objective. That probabilistic state may then be eliminated from the plurality of probabilistic states (for example, eliminated from the MDP).

To assist in this determination, “pruning” data may be determined, the pruning data being based on the directed graph of routing options, but with each node being annotated with a “best case time” and/or a “worst case time”. The best case time for each node would be indicative of the minimum amount of time it will take to get from that node to the end of the journey, assuming that the best case speed can achieved from that node to the end of the journey. The worst case time for each node would be indicative of the maximum amount of time it will take to get from the node to the end of the journey, assuming the slowest possible speed is taken from that node to the end of the journey. Such pruning data may be determined based simply on the directed graph of routing options (since it requires an understanding of only road speed limits and the length of the roads represented by each interconnecting edge). It may be determined at any suitable time, for example after the development of the directed graph of routing options in part A.3 and included in the journey definition, or during the process of determination of a ‘global’ journey policy, such as before Step S1310, or between Steps S1310 and S1320, or between Steps S1320 and 1330, or between Steps S1330 and S1340. Alternatively, the “best case time” may be determined during Step S1340 on a node by node basis. For example, when a probabilistic state is being assessed, the “best case time” for the node identified in the probabilistic state may be determined and then used to assess the value of the time metric in that probabilistic state.

Additionally or alternatively, the heuristic algorithm may assess the value of the efficiency metric in the selected probabilistic state by considering whether the efficiency objective could be met from the probabilistic state with a best case efficiency for the remainder of the journey from the node identified in the selected probabilistic state to the geographic location. This may be determined in a very similar way to that explained in respect of the best case time above, but a best case efficiency may be determined based on the vehicle being used (for example, for the vehicle identified by the vehicle ID, or alternatively for an average vehicle), or a default best case efficiency, and assuming a particular driving speed for the remainder of the journey, for example an average driving speed for each of the remaining interconnecting edges of the journey. The “pruning” data may comprise best case efficiency for each node (in addition, or as an alternative, to the best case time). Alternatively, best case efficiency may be determined during Step S1340 on a node by node basis.

The elimination process of Step S1340 may assess each of the probabilistic states determined in Step S1330 and either eliminate or keep each probabilistic state.

In Step S1350, a decision is made as to whether or not the remaining probabilistic states are all terminated. A terminated probabilistic state is one that has at least one outbound arrow to a next probabilistic state in the MDP (for example, it has at least one ‘child’ state), or is a probabilistic state that comprises a geographical location identifying the end of the journey (for example, the destination location node B when the ‘global’ journey policy is being determined). In the example MDP of FIG. 15, none of the eight probabilistic states yet have a child state (they each have a single inbound arrow, but no outbound arrow(s)) and none of them identify the end location of the journey, for example destination location node B when determining the ‘global’ journey policy (they all identify node C or node D). Therefore, none of the probabilistic states are terminated. If it is decided that not all of the probabilistic states have been terminated, the process proceeds to Step S1360. If it is decided that all of the probabilistic states have been terminated, the process proceeds to Step S1370.

In Step S1360, one of the unterminated probabilistic states is selected and then set to be the parent state for the next iteration of this loop. For example, the uppermost probabilistic state represented in FIG. 15 [Node C, T_{C1}, E_{C1}, P_{C1}] may be selected and set to be the parent state. The process then returns to Step S1320, where possible actions from the unterminated parent state are identified.

With reference to FIG. 14, if the probabilistic state [Node C, T_{C1}, E_{C1}, P_{C1}] has been selected and set to be the parent state, it can be seen that there is no decision to be made regarding the direction in which to travel from node C. Therefore, the only possible route action from probabilistic state [Node C, T_{C1}, E_{C1}, P_{C1}] is “continue”. Again, there may be three different possible speed actions, “fast”, “medium” or “slow”, such that a total of three possible actions may be identified in Step S1320 (although in other implementations, more or fewer possible speed actions may be identified).

In Step S1330, the probabilistic states for the vehicle's arrival at node E (see FIG. 14) may be determined in the same way as described earlier. An example table of the determined probabilistic states is set out below.

| POSSIBLE | | | | | |
|---|---|---|---|---|---|
| ACTIONS | | RESULTING PROBABILISTIC STATE | | | |
| | Possible | | Probabilistic progress metric | | |
| Possible | Speed | Geographical | Time | Efficiency | |
| Route Action | Action | Location | Metric | Metric | Probability |
| Continue | Fast | Node E | T_{E1} | E_{E1} | P_{E1} |
| | | Node E | T_{E2} | E_{E1} | P_{E2} |
| | | Node E | T_{E1} | E_{E2} | P_{E3} |
| | | Node E | T_{E2} | E_{E2} | P_{E4} |
| Continue | Medium | Node E | T_{E3} | E_{E3} | P_{E5} |
| | | Node E | T_{E4} | E_{E3} | P_{E6} |
| | | Node E | T_{E3} | E_{E4} | P_{E7} |
| | | Node E | T_{E4} | E_{E4} | P_{E8} |
| Continue | Slow | Node E | T_{E}₅ | E_{E5} | P_{E9} |
| | | Node E | T_{E6} | E_{E5} | P_{E10} |
| | | Node E | T_{E5} | E_{E6} | P_{E11} |
| | | Node E | T_{E6} | E_{E6} | P_{E12} |

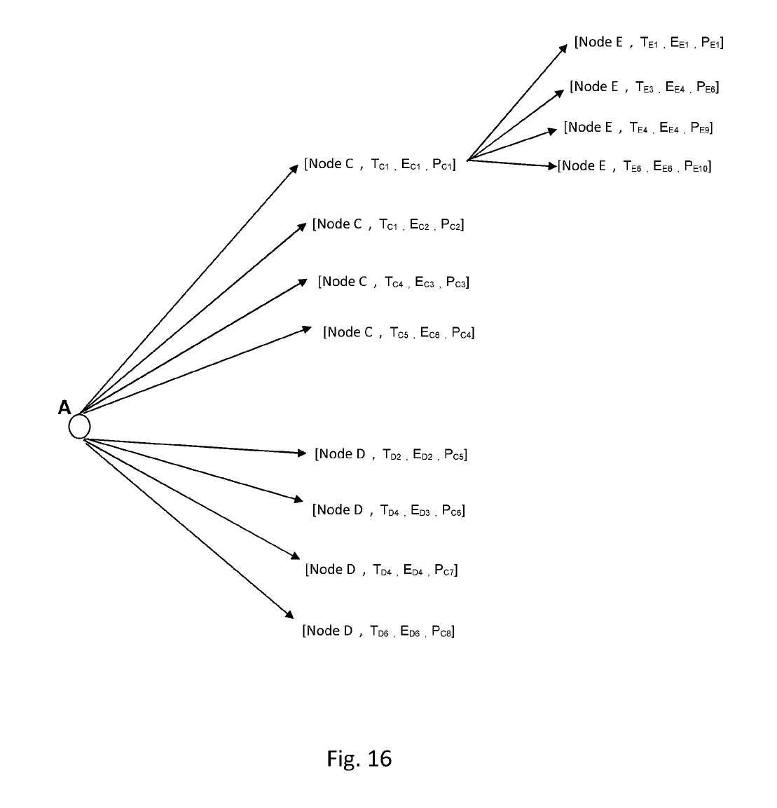

FIG. 16 shows a representation of some of the probabilistic states for node E being added to the MDP, when starting from the probabilistic state [Node C, T_{C1}, E_{C1}, P_{C1}]. It will be appreciated that for the sake of clarity, only four of the 12 probabilistic states identified in the table above have been reproduced in FIG. 16. The values of the time metric and efficiency metric are indicative of a cumulative time and cumulative efficiency from the beginning of the journey (i.e. start location node A when determining the ‘global’ journey policy) to the current location (i.e., node E). Thus, the values of the time and efficiency metrics are indicative of potential journey time and efficiency progress for the journey up to the node indicated in the probabilistic state (in this example, node E).

In Step S1340, an elimination process is performed on the probabilistic states that were determined in Step S1330. The assessment is the same as that described earlier, except that the value of the time metric of each probabilistic state is assessed using the best case time from node E (rather than from Node C, as described earlier). Likewise, the value of the efficiency metric of each probabilistic state is assessed using the best case efficiency from node E (rather than from Node C, as described earlier). That is to say, in Step S1340, each probabilistic state is assessed using the best case time and/or the best case efficiency for the node identified in the probabilistic state. As explained earlier, the probabilistic states that fail the assessment may be eliminated and the probabilistic states that pass the assessment may be kept.

As a further part of the elimination process performed in Step S1340, if none of the determined probabilistic states pass the assessment, the parent state may also be eliminated. For example, in the example set out above where the probabilistic state [Node C, T_{C1}, E_{C1}, P_{C1}] is set to the parent state and the twelve probabilistic states identified in the table above are then determined, if all 12 probabilistic states fail the assessment, the parent state [Node C, T_{C1}, E_{C1}, P_{C1}] may also be eliminated along with the 12 determined probabilistic state. This means that the only probabilistic states that are left in the MDP without any ‘child’ states (i.e., arrows emanating from them) are probabilistic states that have not yet been set to be the parent state. Consequently, the decision in Step S1350 may be performed relatively simply by looking for any probabilistic states that do not have any children and do not identify the end location of the journey (i.e., the destination location node B when determining the ‘global’ journey policy). If all probabilistic states in the MDP have children, or identify the end location of the journey, then all probabilistic states have been terminated. If at least one of the probabilistic states in the MDP does not have at least one child and does not identify the end location of the journey, then not all of the probabilistic states have been terminated.

As can be seen in FIG. 16, there are a number of probabilistic states identifying node C that have not been terminated, a number of probabilistic states identifying node D that have not been terminated and now also a number of probabilistic states identifying node E that have not been terminated. Therefore, when the process proceeds to Step S1350, the answer to the decision will be “No” and the process returns to Step S1360, where one of the unterminated probabilistic states is selected and set to be the parent state for the next iteration of the loop.

The loop of setting an unterminated probabilistic state to be the parent state, identifying possible actions from the parent state, determining probabilistic states, assessing the determined probabilistic states and then deciding whether or not all probabilistic states are terminated may be repeated many times.

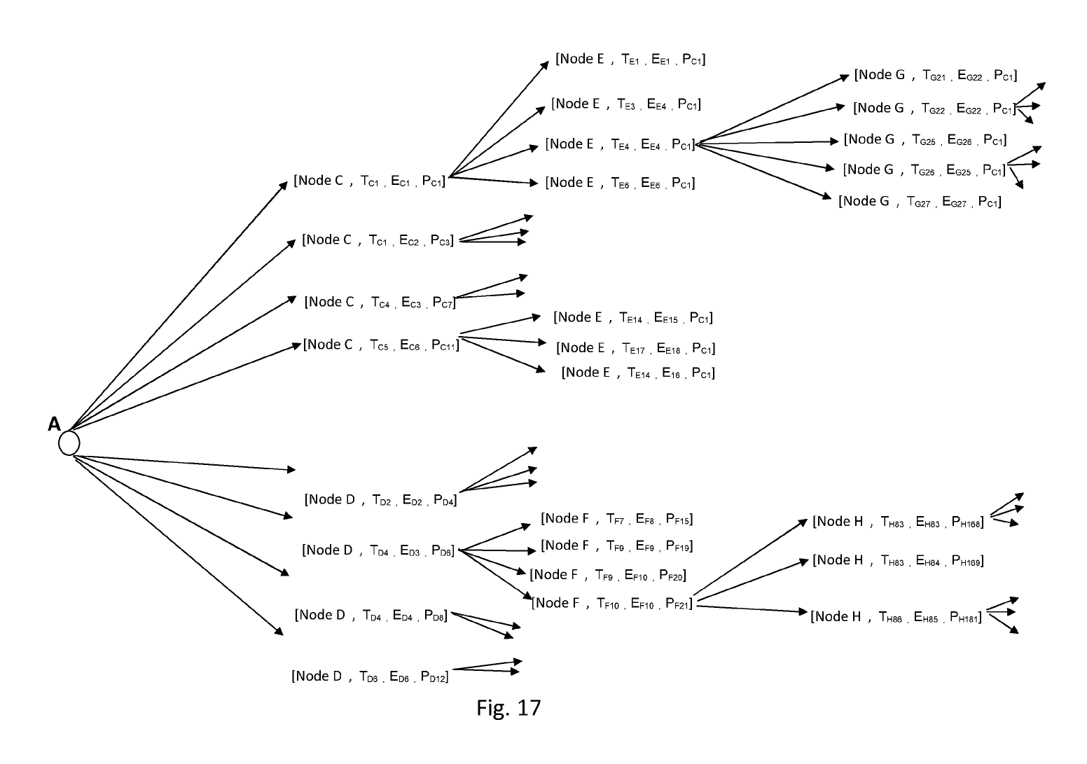

FIG. 17 shows an example representation of the MDP continuing to grow after the loop has been repeated a number of further times. It will again be appreciated that for the sake of clarity only a small portion of the probabilistic states are identified in FIG. 17 and a number of the probabilistic states have arrows emanating from them without the next probabilistic state being represented. It can be quickly appreciated from FIG. 17 that each new probabilistic state determined in Step S1330 may result in a plurality of further probabilistic states emanating from it as the state tree grows.

As will be appreciated, particularly for long and/or complex journeys between A and B where a large number of geographical nodes may be expected in the mesh of routing options, it may be necessary to repeat the loop potentially millions of times in order to terminate all probabilistic states. Performing the elimination process of Step S1340 may help considerably in reducing the size of the MDP and therefore reducing the number of times the loop must be repeated. For example, each probabilistic state determined early in a journey may ultimately result in hundreds of thousands of further probabilistic states further down the MDP. Therefore, eliminating only a single probabilistic state in Step S1340 early in the MDP may result in a significant reduction in the number of times that the loop has to be repeated before Step S1350 decides that all of the probabilistic states have been terminated. Therefore, whilst Step S1340 is an optional step (in an alternative, the process may proceed from S1330 to S1350), it can be appreciated that considerable computational efficiency advantages may be realised, particularly for long and/or complex journeys, by performing Step S1340.

When in Step S1350, if it is decided that all of the probabilistic state are terminated because all probabilistic states either have one or more children state or identify the end location of the journey, the MDP is complete (i.e., all of the plurality of probabilistic states are terminated) the process proceeds to Part B.2 where recommended actions for the journey guidance policy (in this example, the ‘global’ journey policy) are determined.

It will be appreciated that, in general, a directed graph of routing options for a long and/or complex journey may comprise a large number of nodes. Generally speaking, the greater the number of nodes, the more computational difficulty there may be in determining the plurality of probabilistic states. In order to reduce computational overheads for determining the ‘global’ journey policy, a segment of the directed graph of routing options comprising two or more interconnected edges may be amalgamated by replacing it with a ‘coarse’ segment comprising fewer interconnected edges. By doing so, the number of nodes in the directed graph of routing options may be reduced, thereby reducing computational overheads and increasing the speed at which the ‘global’ journey policy may be determined.

This optional step of interconnecting edge amalgamation may take place at any suitable time during the process of determining a journey definition (part A) and/or during the process of determining a ‘global’ journey policy (part B). For example, it may take place before or during the determination of one or more potential routes (Step S430), wherein the directed graph of the mapping data may be modified by replacing a segment comprising two or more interconnecting edges with a coarse segment comprising fewer interconnecting edges than the replaced segment. The determination of one or more potential routes (Step S430) may then be based on the modified directed graph in the mapping data. Alternatively, it may take place before or during the development of the directed graph of routing options in part A.3 described earlier. In this case, a segment comprising two or more interconnecting edges in the one or more potential routes may be replaced with a coarse segment comprising fewer interconnecting edges than the replaced segment. The directed graph of routing options may then be based on the modified one or more potential routes. In a further alternative, a directed graph of routing options may be developed in Part A.3, and then modified later, for example during the determination of the journey definition (but after part A.3), or during the determination of the ‘global’ journey policy in part B (such as before Step S1310). In this case, the directed graph of routing options developed in part A.3 may be considered to be an initial directed graph comprising a plurality of initial interconnecting edges. A segment comprising two or more initial interconnecting edges may then be replaced with a coarse segment comprising one or more interconnecting edges, wherein the number of initial interconnecting edges in the segment is greater than the number of interconnecting edges in the coarse segment. The directed graph comprising the coarse segment may then be the directed graph of routing options used in Steps S1320-S1360.

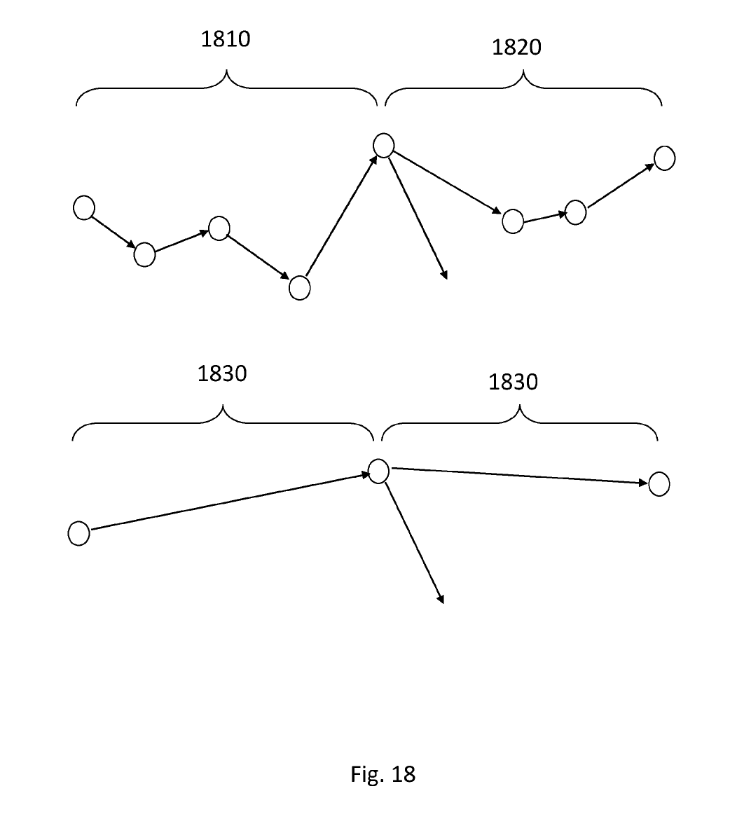

FIG. 18 shows an example representation of two different segments of an initial directed graph of routing options each being replaced with a corresponding coarse segment. Segment 1810 has four initial interconnecting edges and segment 1820 has three initial interconnecting edges. Segment 1810 is replaced with coarse segment 1830 and segment 1820 is replaced with coarse segment 1830 to create the directed graph of routing options. Each of coarse segment 1830 and coarse segment 1840 have only a single interconnecting edge. It will be appreciated that by using this technique, the number of nodes in the directed graph of routing options has been significantly reduced, thereby also reducing computational overheads for the determination of the ‘global’ policy.

Each segment to be replaced with a coarse segment may be identified in any suitable way. For example, interconnecting edge amalgamation may be based on attributes of the interconnecting edges and/or weather data and/or traffic data. For example each of the initial interconnecting edges in the segment may have the same or similar attributes, for example, the same speed limit or an acceptable spread of speed limits (such as no more than a threshold speed difference (e.g., 10 mph) between the maximum and maximum speed limits in the segment), the same road gradient or an acceptable spread of road gradients, etc. Additionally, or alternatively the initial interconnecting edges in the segment may all have sufficiently similar attributes and/or associated weather data and/or associated traffic data to meet an uncertainty threshold. For example, nodes in a directed graph may only have significance where a meaningful navigation and/or speed choice could be made at the node. A meaningful choice may exist where the environment of the interconnecting edge leading away from the node is sufficiently different from the interconnecting edge that leads to the node. For example, traffic conditions may be very different, or the speed limit may be very different, or the level of certainty associated with traffic conditions may be very different, etc. When it is determined that no meaningful choice can be made at the node(s) within a segment, it may be replaced with a coarse segment. It will be appreciated that there are many different ways in which segments may be chosen interconnecting edge amalgamation, for example based on a consideration of interconnecting edge attributes, weather data and/or traffic data, and the present disclosure is not limited to any particular technique. It will be appreciated that it may be preferable to identify segments comprising as many interconnecting edges as possible, in order to achieve the maximum reduction in the number of nodes.

B.2 Determination of Recommended Actions

The recommended actions for a journey guidance policy (for example, the ‘global’ journey policy) are actions that will be recommended to the driver (for example, audibly and/or visually) and/or the vehicle (for example, for autonomous vehicles) during the journey. On the journey, when the vehicle arrives at a node represented in the directed graph of routing options, the recommended action may be used by the route guidance module 110 to suggest a navigation action (for example, ‘turn left’ or ‘continue’, etc) and/or a target speed (for example, drive at 35 mph, etc). Therefore, the recommended actions are actions that will help guide the vehicle on a journey.

The recommended actions may be determined based on the end objectives and the MDP. Therefore, determining the recommended actions for the ‘global’ journey policy may be based on the destination objectives and the MDP.

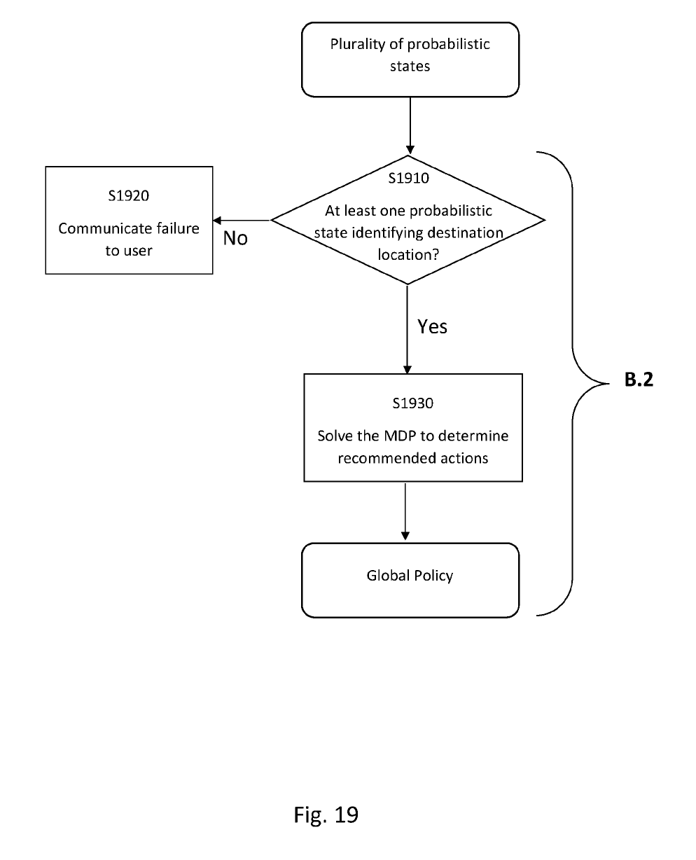

FIG. 19 shows a representation of steps that may be undertaken to determine the recommended actions. The plurality of probabilistic states is received from part B.1 (determination of a plurality of probabilistic states).

In Step S1910 it may be checked whether or not any of the probabilistic states in the MDP comprise an identifier of the end location of the journey (for the ‘global’ journey, this is the destination location node B). If not, the MDP has failed to find any potential ways of arriving at the destination location that would achieve the end objective (for the ‘global’ journey, the destination objective). If none of the probabilistic states identify the end location, the process may proceed to Step S1920, where the user is notified that the end objective cannot be achieved for the journey.

The notification in Step S1920 may simply indicate a failure for the journey, in which case the user could start the whole process again, setting different journey objectives and/or destination objectives in part A. Preferably, Step S1920 would offer the user the chance to change the destination objectives and/or journey objectives. If the user opts to make changes to the objectives, the process may then proceed from Step S1920 to Step S1320 where the plurality of probabilistic states are re-determined based on the changed destination objectives and/or journey objectives. Most preferably, Step S1920 would offer the user comprised destination objectives and/or journey objectives that could be achieved. For example, it may be seen from the MDP which objective(s) are causing the failure and a relaxed, or loosened, compromise on that objective(s) may be offered to the user. For example, it may offer a lower level of energy efficiency for the ‘global’ journey (i.e., a relaxed efficiency objective) and/or a later potential arrival time at the destination location (i.e., a relaxed punctuality objective), etc. If the user accepts the offered compromise, the process may then return to Step S1320 where the plurality of probabilistic states are re-determined based on the compromised destination objectives and/or journey objectives. It will be appreciated that in an alternative implementation, this check may take place during part B.1, for example, after Step S1350 has decided that all probabilistic states have been terminated, but before the plurality of probabilistic states are passed to part B.2.

If at least one of the probabilistic states comprises an identifier of the end location of the journey, the process may proceed to Step S1930 where recommended actions for each of the plurality of probabilistic states is determined.

The recommended actions are determined by solving the MDP, for example using value iteration and/or policy iteration. The skilled person will readily appreciate how to solve an MDP using value iteration and/or policy iteration. The solution to the MDP may identify for each probabilistic state which of the possible actions should be taken based on the action that results in the highest probability of achieving the destination objectives, or highest expectation of achieving the destination objectives, or the best outcome at the destination location relative to the destination objective (for example, the best arrival time relative to the punctuality objective and/or the best efficiency relative to the efficiency objective), or some combination of these. The skilled person will appreciated that there are many different ways in which an MDP may be solved in order to identify the recommended action at each state (i.e. at the initial state and each probabilistic state), some of which are explained here: http://artint.info/html/Artint_224.html.

It will be appreciated that, in general, the MDP for a long and/or complex journey may comprise a very large number of probabilistic states. Typically, the larger the number of probabilistic states, the more computationally difficult it may be to solve the MDP. Utilising the node amalgamation technique described earlier may help to reduce the size of the MDP and therefore reduce the computational difficulty of solving the MDP. Additionally, or alternatively, computational difficulty of solving the MDP may be reduced by solving the MDP using sampling-based techniques, rather than techniques such as value iteration. Sampling-based techniques can trade-off the precision and optimality of methods like value iteration, against the ability to obtain results on probabilistic models with extremely large state spaces. The MDPs may be solved with sampling techniques such as UCT (which stands for ‘Upper Confidence Bound (UCB) applied to Trees’), which is a Monte-Carlo Tree Search algorithm, meaning that the journey guidance policy is derived using a combination of heuristic search and stochastic simulations, which explore the most likely executions through the MDP. The sampling-based methods can be driven by the journey objectives, as described above.

Reducing the computational difficulty of creating the MDP and/or solving the MDP may be particularly useful for unconstrained transportation networks. A constrained transportation network is one where the route to be taken on a journey is constrained—i.e., there is no flexibility or choice on the route to be taken on a journey—and/or where the potential for traffic disruption is limited. One example of a constrained transportation network is a train network, where there is only one specific route that a train may take and very little potential for changing levels of disruption along the journey. Consequently, it can be seen that a constrained transportation network is a relatively simplistic type of transportation network, where only recommended speed actions may be needed. As a result of the lack of route choice and/or low frequency and potential for disruptions during the journey, a very limited number of decision nodes and/or probabilistic states may be required, which may keep computational complexity and overheads relatively low. An unconstrained transportation network, on the other hand, is a far more complex network where the route to be taken on a journey is unconstrained (i.e., there is flexibility or choice on the route to be taken on a journey) and/or there is far greater potential for changing levels of disruption long the journey. Some examples of unconstrained transportation networks are road networks, shipping networks and air travel networks. In these examples, not only may different routes be taken in order to reach a destination location, disruption on the journey may vary regularly throughout the journey (for example, potentially changing every 5-50 m) as a result of varying levels of traffic and/or changing sea or air currents (in the example of shipping and air travel). As a result, a significantly larger number of decision nodes are likely to be required on unconstrained transportation networks. Furthermore, a larger number of probabilistic states may also be required, since variable levels of disruption may introduce a greater potential number and spread of probabilistic progress metrics for each geographical location along the journey. It will therefore be appreciated that unconstrained transportation networks are considerably more complex than constrained transportation networks, and so providing guidance on route and speed actions on unconstrained transportation networks may be considerably more difficult than on constrained transportation networks.

It can be seen that guidance techniques developed specifically for constrained transportation networks may not be straightforwardly applied to unconstrained networks, since they do not properly take into account the considerable increase in the complexity. For example, because guidance on unconstrained transportation networks is so much more complex, simply applying constrained transportation network guidance techniques to an unconstrained transportation network may result in impracticable computational overheads, potentially causing the entire system to fail. However, the techniques described herein may be used for constrained and unconstrained transportation networks, since they have been devised with the complexity of unconstrained transportation networks in mind. Furthermore, by optionally using the node amalgamation and/or sampling based MDP solution techniques described above, the techniques described above can be made even further scalable and are therefore particularly useful for complex, unconstrained transportation networks.

In our earlier example, 24 possible actions were identified from node A (see part B.1 above). When determining the ‘global’ journey policy, solving the MDP will identify the most preferable action to take at node A in order to arrive at node B and achieve the destination objectives. Likewise, from the probabilistic state [Node C, T_{C1}, E_{C1}, P_{C1}], 12 possible actions were identified (see part B.1 above). Solving the MDP will identify the most preferable action to take from that probabilistic state.

Consequently, when the vehicle arrives at a node during the journey (for example, when it arrives at node C), the route guidance module 110 may consider a current progress metric (i.e., the current actual time for the journey so far and/or the current actual energy consumption for the journey so far), identify a corresponding probabilistic state and then utilise the recommended action associated with that probabilistic state (this is explained in more detail below).

Having solved the MDP in Step S1930, the journey guidance policy is created using the plurality of probabilistic states and the recommended actions identified in Step S1930. The journey guidance policy may be better understood by considering an example ‘global’ journey policy represented in the following table:

| | Recommended action | | |
|---|---|---|---|
| | Route | Speed | |
| State | action | action | Next probabilistic states |
| [Node A, T₀, E₀] | Left | Medium | All probabilistic states |
| | | | identifying Node C |
| [Node C, T_{C1}, E_{C1}, P_{C1}] | Continue | Fast | All probabilistic states |
| | | | identifying Node E |
| [Node C, T_{C3}, E_{C3}, P_{C5}] | Continue | Medium | All probabilistic states |
| | | | identifying Node E |
| [Node D, T_{D6}, E_{D5}, | Continue | Medium | All probabilistic states |
| P_{D10}] | | | identifying Node F |
| | | | [Node F, T_{F26}, E_{F25}, |
| | | | P_{F61} |
| [Node F, T_{F17}, E_{F18}, | Continue | Medium | All probabilistic states |
| P_{F33}] | | | identifying Node H |
| | | | [Node H, T_{H33}, E_{H33}, |
| | | | P_{H96}] |
| [Node H, T_{H2}, E_{H1}, P_{H3}] | Right | Slow | All probabilistic states |
| | | | identifying Node J |
| | | | [Node J, T_{J8}, E_{J9}, |
| | | | P_{J18}] |
| . . . | . . . | . . . | . . . |

Solving the MDP also offers the opportunity for further analysis to be performed on the MDP. For example, identifying the probability that the ‘global’ journey policy can meet the destination objectives and/or identifying likely performance relative to an objective that is not part of the destination objective (for example, if the destination objective comprises only the punctuality objective, the expected level of energy consumption for the ‘global’ journey policy may be determined from the MDP). Thus, it will be appreciated that the MDP may offer the opportunity to perform various types of analysis relating to the ‘global’ journey and the outcome of that analysis to be reported to the user (for example, the probability that the destination objectives will be achieved may be communicated to the user of the route guidance module 110 at the start of the ‘global’ journey).

The above table includes a field ‘next probabilistic states’. This identifies the node that will be reached next based on the route action of the recommended action. Therefore, it is expected that during the ‘global’ journey, by following the recommended action, when the vehicle arrives at that next node, the current journey state of the vehicle (i.e., the time and energy consumption for the journey so far) should correspond with one of the probabilistic states that identifies the next node. For example, by following the recommended action from node A, the vehicle should later arrive at node C and the current journey state on arrival at node C should correspond with one of the probabilistic states in the MDP that identifies node C. Thus, the range of values of time metrics in the probabilistic states that identify node C represent the range of potential values of time metrics for the current state on arrival at node C and the range of values of efficiency metrics represent the range of potential values of efficiency metrics for the current state on arrival at node C. However, the field ‘next probabilistic state’ in the ‘global’ journey policy is optional and the next probabilistic states may alternatively be determined any other suitable way, for example by referring to the MDP. It will be appreciated from discussions later in this disclosure that when a ‘local’ journey policy is utilised, determining the range of values of time metrics and range of values of efficiency metrics in the probabilistic states relating to the next node that will be reached on the ‘global’ journey may be useful.

It will also be appreciated that the ‘global’ journey policy above is representative of only a very small sample of states and recommended actions and that each state in the MDP may be identified in the ‘global’ policy with a corresponding recommended action.

Having determined the ‘global’ journey policy, the ‘global’ journey from the start location may commence with the route guidance module 110 guiding the driver and/or vehicle with recommended actions for the route (as explained later).

Guidance During the Journey

FIG. 20 shows an example of how a journey guidance policy may be used during a journey. This will initially be explained in the context of the journey being a ‘global’ journey and the journey guidance policy being a ‘global’ journey policy.

In Step S2010, the current journey state is determined. The current journey state comprises the current geographical location and a current progress metric. The current geographical location may be obtained from the location module 118. The current progress metric comprises a current time metric that is indicative of the time taken on the journey so far (for example, a cumulative time for the ‘global’ journey so far, such as 1 hour, 15 minutes, or the current time, such as 14:43, etc) and a current efficiency metric that is indicative of the efficiency of the journey so far (for example, the amount of energy utilised in the ‘global’ journey so far, such as 10 litres of fuel, or 23 kWh, etc).

At the start of the example ‘global’ journey represented in FIG. 14, the current journey state would comprise a geographical location corresponding to node A, a current time metric indicating that the ‘global’ journey has so far taken no time and a current efficiency metric indicating that the ‘global’ journey has so far taken no energy.

In Step S2020, the current journey state is compared with the states in the journey guidance policy in order to identify a corresponding state in the journey guidance policy. At the start of the example ‘global’ journey represented in FIG. 14, this may be relatively straightforward, as there is likely to be only one state in the ‘global’ journey policy that identifies node A.

In Step S2030, a recommended action is selected from the journey guidance policy. The selected recommended action is the recommended action corresponding to the state identified in Step S2020 as corresponding to the current journey state. For the example ‘global’ journey represented in FIG. 14 and example ‘global’ journey policy described in part B.2 above, at the start of the ‘global’ journey, the relevant state in the ‘global’ journey policy would be [Node A, T₀, E₀] and the corresponding recommended action would comprise be: Route action: Left; Speed action: Medium.

In Step S2040, action data 130 based at least in part on the recommended action is output, (see FIG. 1). The action may be the recommended action, or guidance based on it (for example, the recommended route action may comprise “left” and the action data may comprise an instruction to display “turn left at the next junction”, etc). Guidance may then be communicated to the driver. For example, where the route guidance module 110 comprises a display screen and/or speakers, the action data 150 may be communicated to the driver as a visual speed and navigation instruction using the display screen and/or as an audible instruction using the speakers.

[symbol] ptionally, the action data 130 may be output at a time that is determined based at least in part on the Driver ID. For example, the route guidance module 110 may, over time, learn how quickly a particular driver responds to particular commands (for example, how quickly they react to a change in target speed). A driver's typical response timings can be stored with an associated driver ID (for example, in the memory module 114), which may be looked up when a recommended action is selected and then used to determine when the action data 130 should be output so that it can be communicated to the driver at the optimal time.

FIG. 21 shows an example of the route guidance module 110 comprising a display screen that displays the speed action as a target speed 2110 (in this example, 99 mph). As explained earlier, the terminology “slows”, “medium” and “fast” for the speed action have been used in this disclosure for the sake of clarity to represent actual target speeds. Therefore, in this example, the word “medium” for the recommended speed action from node A would in practice be a value “45 mph”. The route action is also displayed as a navigation instruction 2120 (in this example, ‘turn left now at upcoming junction’). In this example, an acceleration action 2130 (in this case, ‘accelerate now’) is also communicated to the driver. The route guidance module 110 may be configured to determine the acceleration action 2130 by comparing the current speed of the vehicle with the target speed 2110.

If the route guidance module 110 does not itself comprise a display screen and/or speakers, the action data 130 may be output to a vehicle display/speaker controller, or augmented reality glasses, or an HUID so that guidance based on the action data may be communicated to the driver using a display screen and/or speakers built into the vehicle.

If the vehicle is an autonomous vehicle ([SAE1]-[SAE5]), the action data 130 may be output to a vehicle controller for use in autonomous control of the vehicle.

Continuing with our example ‘global’ journey, the vehicle may now set off from node A towards node C. After leaving node A, the route guidance module 110 may update the route instruction 220 to instruct “continue”, so as not to cause navigation confusion when travelling to node C.

In Step S1350, it may be decided whether or not the vehicle has reached the end location of the journey (for the ‘global’ journey, the destination location node B). If it has not, the process returns to Step S2010. If it has, the journey is complete.

In our example ‘global’ journey, as the vehicle approaches the next node (node C), Step S2020 may recognise that there are one or more probabilistic states in the ‘global’ journey policy that identify node C. For example, the current location of the vehicle may be within a proximity threshold, which could define a distance from the node and/or an expected time from the node (for example, the proximity threshold could be a distance, such as 10 m, or 50 m, or 100 m, or 75 yards, or 170 yards, 200 yards, etc, so that when the vehicle is within that distance, it is within the proximity threshold, or it could be a time, such as 5 seconds, or 8 seconds, or 20 seconds, or 1 minutes, etc such that when the expected time before arriving at the node is less than the threshold, the vehicle is within the proximity threshold) of node C. Recognition of the vehicle approaching the next node (node C) and entering the proximity threshold may be achieved in any way that will be readily understood by the skilled person.

When Step S2020 identifies that the current geographical location in the current journey state is close to the geographical location identified in at least one probabilistic state in the ‘global’ journey policy, it may proceed to Step S2030, where a recommended action is selected.

The value of the current progress metric in the current state may be extrapolated to an extrapolated value that is indicative of an expected value of the progress metric on arrival at the next node. This may be performed in any suitable way, for example based on any one of: the current speed of the vehicle; the current efficiency of the vehicle; traffic data and/or weather data, etc. Because the vehicle will be relatively close to the next node, the extrapolated value may be assumed to be quite an accurate prediction of what value the current progress metric will have when the vehicle arrives at the next node. The selected recommended action is the recommended action corresponding to one of the probabilistic states identifying the upcoming node (node C). In some instances, it may be straightforward to select the recommended action because one of the probabilistic states identifying node C may have probabilistic progress metric values that are the same as the extrapolated values, in which case the selected recommended action would be the recommended action corresponding to the probabilistic state. In other instances, none of the values of the probabilistic progress metrics in the probabilistic states that identify the upcoming node may be the same as the extrapolated values. In this case, a recommended action may be selected in a number of different ways. For example, it may be the recommended action corresponding to the probabilistic state comprising a value of time metric most closely corresponding to the extrapolated value for the current time metric, or the recommended action corresponding to the probabilistic state comprising a value of efficiency metric most closely corresponding to the extrapolated value for the current efficiency metric, or some compromise between those two. Which of the many different ways in which the selection is made in Step S2030 is dependent on the implementation chosen for the route guidance module 110. In any event, it will be appreciated that the recommended action may be selected from any of the probabilistic states that identify the upcoming node, for example, based on the extrapolated values and the values of time metrics and/or progress metric in the probabilistic states that identify the upcoming node.

In an alternative, the recommended action may be selected on arrival at the upcoming node, in which case extrapolation may not be required and the values of the current time metric and/or current efficiency metric may be used to select the recommended action.

Optionally, in Step S2030, it may be considered whether or not the extrapolated value (or value of current time metric and/or efficiency metric in the case where the recommended action is selected on arrival at the upcoming node) exceeds time metric and/or efficiency metric in all of the probabilistic states identifying the upcoming node by more than a threshold amount. Exceeding the values of the time metric and/or efficiency in all of the probabilistic states identifying the upcoming node by more than a threshold amount may indicate that time and/or efficiency for the journey so far are progressing poorly, thereby jeopardising the achievement of the destination objectives. The threshold amount may be set to any value, for example 0 minutes, 1 minute, 2 minutes, 4.3 minutes, 0 litres/gallons, 0.1 litres, 3 mpg, 0 kWh, 0.5 kWh, 0.8 kWh, etc). For example, if it is set to 2 minutes for the time metric, Step S2030 would consider whether or not the extrapolated value for the time metric exceeds the value of the time metric plus the failure threshold (2 minutes) for all of the probabilistic states identifying the upcoming node. If at least one of the probabilistic states passes this assessment, the recommended action may be selected as described above from one of those probabilistic states that passes this assessment. If the extrapolated value exceed the value of the time metric and/or efficiency metric for all probabilistic value identifying the upcoming node, a failure action may be performed rather than proceeding to Step S2040.

The failure action may be to communicate to the driver and/or vehicle that the destination objectives can no longer be met (for example, as described in part A.4 above). A compromise of destination objectives may be offered to the user and a new ‘global’ policy determined based on those compromised objectives from the current location to the destination location (as explained in part A.4 above).

If a recommended action is selected in Step S2030, action data 130 based on the selected recommended action is then output in Step S2040 and the whole process continues until the ‘global’ journey is complete.

The considerable benefits of the ‘global’ journey policy and techniques for route guidance of the present application may now be most fully appreciated. Owing to the unconstrained environment of the road network, time and energy progress along each interconnected edge may not be predicted in advance with certainty. The recommended action that is selected at each node may be different depending on how well the journey has progressed up to that point. For example, if the vehicle travels from node A to node C relatively quickly, it may arrive at node C in a current journey state that corresponds to a probabilistic state with a recommended action to drive relatively slowly for the next interconnecting edge to node E. The ‘global’ journey policy has been determined in a way that means that the punctuality objective for the ‘global’ journey should still be achieved by driving the next part of the ‘global’ journey relatively slowly, but overall efficiency for the ‘global’ journey may be improved by driving the next part relatively slowly, thereby achieving the best outcome at the destination location. Conversely, if, for example, traffic conditions were relatively bad between node A and node C, the current journey state at node C may correspond to a different probabilistic state with a recommended action to drive relatively quickly for the next interconnecting edge to node E. Again, the ‘global’ journey policy has been determined in a way that means that the efficiency objective for the ‘global’ journey should still be achieved by driving the next part of the ‘global’ journey relatively quickly, but lost time may be made up for the ‘global’ journey by driving the next segment relatively quickly, thereby helping to achieve the punctuality objective and the efficiency objective for the ‘global’ journey. Thus, by determining a journey guidance policy (such as the ‘global’ journey policy) based on the destination objectives as described above, recommended actions may be determined along the journey that best meet the needs of achieving the overall destination objectives. This is in stark contrast to techniques that determine recommended action based on short term goals, such as maximise efficiency along the current stretch of road, which can result in a failure to meet long-term goals. This may be particularly true where the destination objectives comprise both efficiency and punctuality objectives, since these can often be conflicting objectives. By determining the journey guidance policy based on both efficiency and punctuality objectives, the recommended actions may be determined that along the journey that offer the best probability of meeting both objectives. In contrast, if a recommended action such as a speed action is determined based on a short-term goal, such as a short-term efficiency goal, a long-term goal of relating to destination arrival time and/or overall journey efficiency may be jeopardised.

It will also be appreciated that the route action may also change depending on the current state when the vehicle arrives at the next node. For example, solving the MDP to determine the ‘global’ journey policy may have determined that it would be best to turn left if the value of the current efficiency metric is relatively bad but the value of the current time metric indicates that good time progress has been made so far, and that it would be best to turn right if the value of the current efficiency metric is relatively good but the value of the current time metric indicates that poor time progress has been made so far (because the route taken by turning left is likely to be more efficient, but take longer, than the route taken by turning right).

Furthermore, the ‘global’ journey policy may also have recognised by virtue of solving the MDP that, owing to the time specific nature of predicted weather conditions and/or traffic conditions partway through the ‘global’ journey, it is preferable to traverse an initial portion of the ‘global’ journey at a relatively high speed and low efficiency to try to get beyond an expected region of bad weather conditions and/or traffic conditions before they happen, and then travel at a relatively slow speed and high efficiency for the remainder of the ‘global’ journey (for example, if bad traffic is predicted on an interconnecting edge at 4 pm, it may be preferable for time and efficiency to travel quickly initially in order to get to and traverse that interconnecting edge before 4 pm, and then travel relatively slowly thereafter).

Finally, since the ‘global’ journey policy was determined in consideration of the journey objectives, they should also be met by the recommended actions throughout the ‘global’ journey.

Thus, it can be seen that in accordance with the present disclosure, a particular, rigid navigation route is not set at the beginning of the ‘global’ journey. A considerably more flexible ‘global’ journey policy is determined that does not set a single route and/or speed profile. Thus, helpful guidance which responds to actual progress and changing conditions along the route may be provided throughout the ‘global’ journey to help achieve the best outcome for the ‘global’ journey and achieve the journey and destination objectives. Furthermore, the driver need not be told anything other than the next speed and navigation instruction, since the speed profile and route to be taken for the journey is flexibly chosen by recourse to the ‘global’ journey policy as the journey progresses. Thus, the process of using the route guidance module 110 may be simplified.

It will be appreciated from the description of Steps S2020 and S2030 that the larger the number of probabilistic states in the ‘global’ journey policy, the more likely it is that a good match may be found with the current state of the journey, and therefore the more helpful the recommended action may be. As explained in part B.1, the number of probabilistic states may be increased by identifying a greater number of possible actions in Step S1320 and/or by determining a greater number of probabilistic states for each identified possible action. However, the larger the number of determined probabilistic states, the greater the computational overhead for determining the ‘global’ policy. Therefore, the benefits of the elimination process (Step S1340) and/or the amalgamation of interconnecting edges in the directed graph of routing options (which reduce computational overheads) may be most fully appreciated now since reducing computational overheads in this way may enable a larger number of probabilistic states to be included in the ‘global’ journey policy whilst still staying within reasonable computational bounds.

The number of probabilistic states determined may be different at different stages of a journey, by identifying a greater number of possible actions and/or determining a greater number of probabilistic states for each identified possible action. For example, more probabilistic states may be identified from a state early in the journey, compared with states later in the journey (for example, a larger number of probabilistic states, which may together represent a large range of values of time metric and/or efficiency metric, may be determined for each possible action taken from the initial state, compared with for each possible action taken from a probabilistic state later in the journey). This may be because the vehicle may set off on the journey a little later than expected (for example, the ‘global’ journey policy may be determined assuming that the journey will begin immediately, but in fact it may begin sometime later, such as 1-5 minutes later while the driver readies themselves for the journey). By generating a larger number of probabilistic states, it is more likely that a relevant probabilistic state can be found in the ‘global’ journey policy on arrival at the next node in the ‘global journey’. The number of next probabilistic states determined from each state may vary depending on a number of different factors, such as time/distance into the journey, complexity of the navigational environment (for example, the road network) at, and/or immediately preceding a node identified in the next probabilistic states (for example, a very complex road feature just immediately preceding a node may mean that it is beneficial to determine a larger number of probabilistic states for that node, since there is likely to be a larger range of potential time and/or energy to traverse that complex road feature), etc.

The ‘global’ journey policy may be determined prior to the journey starting, with route guidance being based only on the recommended actions of the ‘global’ journey policy and, therefore, only being provided after the ‘global’ journey policy has been determined. However, in an alternative, the journey may begin before the ‘global’ journey policy is determined, with the ‘global’ journey policy being determined during the journey, and once it is determined, it is used for the remainder of the journey. For example, determination of the ‘global’ journey policy may take a long time (such as 1-10 minutes), particularly for a long ‘global’ journey. If a driver wishes to commence the journey immediately, waiting this long may be frustrating. Therefore, the route guidance module 110 may be configured to offer the driver the option to begin the journey immediately with just navigation guidance based on the journey definition or basic navigation instructions from an existing navigation API etc. The ‘global’ journey policy may then be determined during the initial part of the journey and once determination is complete, it may be used (for example, after the ‘global’ journey policy has been determined, as the vehicle approaches the next node in the ‘global’ journey, a recommended action may be selected in the ‘global’ journey policy, as explained earlier).

Whilst using the ‘global’ journey policy to guide the ‘global’ journey may achieve significant benefits and advantages, preferably a ‘local’ journey policy is also utilised in order to achieve even further benefits and advantages. In this situation, in Step S2040, rather than outputting the action data, the recommended action and current state may be sent to the determination of a ‘local’ journey policy (Part C).

C Determination of a ‘Local’ Journey Policy

In this disclosure, the term “‘local’ journey” is used to describe a part of the ‘global’ journey. For example, the ‘local’ journey is a journey between a first location and a second location, wherein at least one of the first location and the second location are an intermediate node (such as node C, or node D, or node G, etc in FIG. 14) on the ‘global’ journey. Typically, the ‘local’ journey will be the journey along an interconnecting edge in the directed graph of routing options (for example, the journey between node C and node E, or between node F and node H in FIG. 14). However, it may alternatively be a journey along a plurality of interconnecting edges (for example the journey from node D to node H in FIG. 14).

Determination of a ‘local’ journey policy is very similar to the determination of a ‘global’ journey policy, as explained in part B above. Therefore, reference will regularly be made to part B above, and to FIGS. 12, 13 and 19.

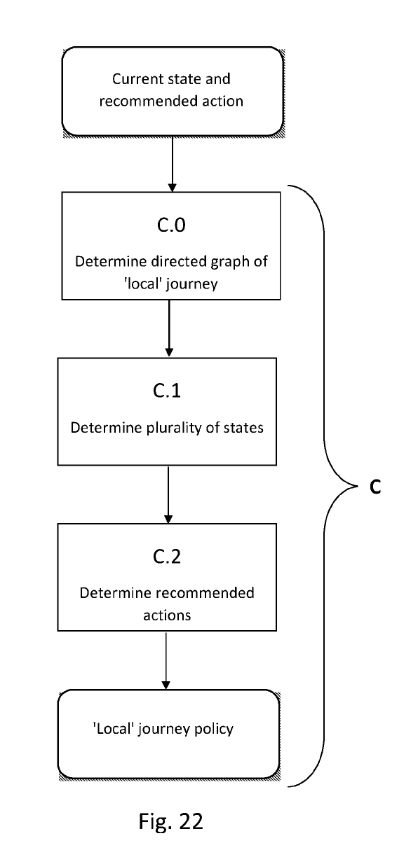

FIG. 22 shows example steps to determine a ‘local’ journey policy.

In Step C.0, a directed graph of the ‘local’ journey is determined. When a ‘local’ journey policy is to be determined, the recommended actions in the ‘global’ journey policy should include the next probabilistic state (as identified in part B.2 above). In this case, the end location for the ‘local’ journey is the next node that will be reached on the ‘global’ journey (for example, the geographical location identified in the ‘next probabilistic state’ field of the ‘global’ journey policy) and the start location for the ‘local’ journey may be geographical location of the node on the ‘global’ journey that the vehicle has just reached, or is within the proximity threshold of. For example, as the vehicle approaches node C and looks up the recommended action in the ‘global’ journey policy, the start location of the ‘local’ journey will be node C and the end location of the ‘local’ journey will be node E. Therefore, the interconnecting edge for the ‘local’ journey may be identified to be the interconnecting edge that will be traversed from the upcoming node to the subsequent node in the ‘global’ journey. Considering the example of FIG. 14, at the very start of the ‘global’ journey, the next interconnecting edge will be the edge between node A and node C. The start location of the ‘local’ journey will be node A and the end location of the ‘local’ journey will be node C.

Having identified the next interconnecting edge, a directed graph of the ‘local’ journey may be determined by subdividing the next interconnecting edge into a plurality of interconnecting edges (i.e., two or more interconnecting edges).

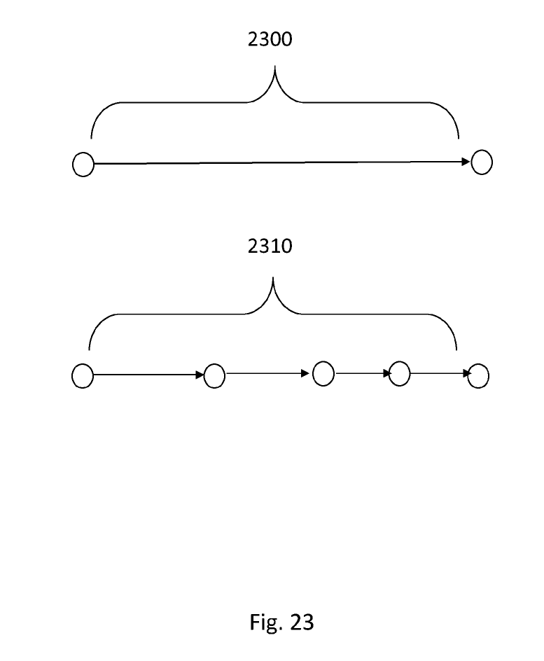

FIG. 23 shows an example representation of how the next interconnecting edge 2300 may be subdivided into a plurality of interconnecting edges and nodes 2310, which together make the directed graph of the ‘local’ journey. The plurality of interconnecting edges and nodes 2310 together make up a ‘fine segment’. The subdivision may take place in any suitable way, for example the next interconnecting edge 2300 may be subdivided into a number of equal length interconnecting edges, or road characteristics of the next interconnecting edge 2300 may be analysed to subdivide it into the plurality of interconnecting edges 2310 by inserting one or more nodes into the next interconnecting edge 2300 (for example, a node may be introduced where there is a pedestrian crossing, or a change in gradient, or any other characteristic that may introduce some uncertainty in the progress of the vehicle along the next interconnecting edge 2300, etc). In the example of FIG. 23, three nodes have been inserted, such that the next interconnecting edge 2300 has been subdivided into five interconnecting edges 2310. Whilst the plurality of interconnecting edges 2310 together define only one route, it will be appreciated that they are a directed graph and may be thought of as a directed graph of routing options, wherein there is only one potential route defined from the start of the ‘local’ journey to the end of the ‘local’ journey (i.e., only one routing option). Therefore, for the sake of steps C.1 and C.2, the directed graph of the ‘local’ journey is a directed graph of routing options.

Where interconnecting edge amalgamation (described in part B.1 above) was performed during determination of the ‘global’ policy, subdivision of at least one interconnecting edge may be used to return some of the detail that was lost as a result of interconnecting edge amalgamation. Therefore, interconnecting edge attributes may be associated with each of the interconnecting edges in the fine segment, wherein those interconnecting edge attributes are the interconnecting edge attributes of the interconnecting edges that were amalgamated to create the ‘coarse’ segment.

Having determined the directed graph of the ‘local’ journey, a plurality of states may be determined in Step C.1. This step may be carried out in the same way as that described above in respect of Step B.1, with the initial state being the current state or a state identifying the upcoming node and extrapolated values of the current time metric and current efficiency metric. The end objectives may comprise a time objective based on the range of values of time metrics in the probabilistic states that identify the end location of the ‘local’ journey and/or an efficiency objective based on the range of values of efficiency metrics in the probabilistic states that identify the end location of the ‘local’ journey. For example, the time objective may be the range of values of time metrics in the probabilistic states that identify the end location of the ‘local’ journey, or some value within that range, and the efficiency objective may be the range of values of efficiency metrics in the probabilistic states that identify the end location of the ‘local’ journey, or a value within that range. The time objective and/or efficiency objective may optionally be determined based on the destination objective for the ‘global’ journey. In any event, it will be appreciated that the end objective for the ‘local’ journey is an objective that means that when the vehicle arrives at the end of the ‘local’ journey, it should have a current journey state whereby there will be at least one similar probabilistic state in the ‘global’ journey policy so that a recommended action may be chosen for the next interconnecting edge of the ‘global’ journey. At each parent state during the determination of the plurality of states for the ‘local’ journey (i.e., at Step S1320 in the process represented in FIG. 13), there is no choice in route to take, so the possible route action will only be ‘continue’. Thus, the possible actions from the parent state during step C.1 may be identified only as possible speed actions (for example, ‘fast’, ‘medium’, or slow’), which means that determining the plurality of probabilistic states for the ‘local’ journey policy may generally be quicker than for the ‘global’ policy, since fewer probabilistic states should be determined. It will be appreciated that any number of possible speed actions may be identified, and for each of those any number of probabilistic states may be identified. The number of possible speed actions may be the same as, or different to, that used for determining the ‘global’ journey policy, and the number of probabilistic states determined for each possible action may be the same as, or different to, that determined for determining the ‘global’ journey policy.

Consequently, Step C.1 may determine an MDP for the ‘local’ journey. In the example where the journey has not yet begun and the vehicle is still at node A in FIG. 14, the MDP may relate to the ‘local’ journey between node A to node C, and may identify a plurality of probabilistic states each comprising a geographic location identifying a node on the ‘local’ journey directed graph between node A and node C.

In part C.2, recommended actions may then be determined so that a ‘local’ journey policy may be determined. Again, this step may be carried out in the same way as that described above in respect of Step B.2, with an MDP comprising the probabilistic states determined in part C.1 being solved. Thus, a ‘local’ journey policy comprising a plurality of states, each with a corresponding recommended action, may be determined in the same way as the ‘global’ journey policy was determined. Each recommended action in the ‘local’ journey policy will comprise a recommended speed action (since no route actions can be identified in Step C.1 because there is only one route from the start location of the ‘local’ journey to the end location of the ‘local’ journey).

Having determined the ‘local’ journey policy, it may be used to guide the vehicle on the ‘local’ journey in the same way as that described above, and represented in FIG. 20, in respect of the ‘global’ journey. In particular, the current journey state on the ‘local’ journey is compared with the states in the ‘local’ journey policy and a recommended action is selected from the ‘local’ journey policy. Action data based on the selected recommended action is then output to guide the driver, or the autonomous vehicle for the next interconnecting edge of the ‘local’ journey. This is repeated for each interconnecting edge of the ‘local’ journey (i.e., as the vehicle approaches the next node in the ‘local’ journey, the next recommended action is selected and output) until the vehicle arrives at the end location of the ‘local’ journey. As the vehicle approaches the next node on the ‘global’ journey, the route guidance module 110 will again select a recommended action from the ‘global’ policy, use it to instruct a route action and also use it to determine and subsequently utilise a ‘local’ journey policy for guiding speed on the next interconnecting edge of the ‘global’ journey.

Thus, it can be appreciated that as the vehicle approaches the next node in the ‘global’ journey (for example, node C in FIG. 14), the ‘global’ journey policy is used to select a recommended action for the next interconnecting edge (for example, node C to Node E in FIG. 14). The recommended action can then be used to instruct a route action that should be taken at the next node on the ‘global’ policy and to determine a ‘local’ journey policy for the next interconnecting edge, which can be used to provide more fine-grain speed guidance along that ‘local’ journey along the next interconnecting edge.

Determining and using a ‘local’ journey policy in this way may be beneficial because of uncertainties in how the vehicle will progress along the next interconnecting node of the ‘global’ journey. In particular, interconnecting edges of the ‘global’ journey have the potential to be quite long (particularly where amalgamation of interconnecting nodes has taken place for the determination of the ‘global’ journey policy) and a wide range of values of time metrics and/or efficiency metrics may be achieved at the end of an interconnecting edge if the speed action recommended by the ‘global’ journey policy is used for the whole of that interconnecting edge. By determining and using a ‘local’ journey policy, the target speed for the vehicle may be adjusted a number of times during the ‘local’ journey (because a new recommended action in the ‘local’ policy is selected each time the vehicle approaches the next node in the ‘local’ journey). This may improve the chances that the vehicle will arrive at the end of the ‘local’ journey in a current state that closely corresponds with the values in the ‘next probabilistic state’ of the recommended action that was selected from the ‘global’ journey policy, thereby keeping the vehicle on track with the intentions of the selected recommended action of the ‘global’ journey policy. For example, as the vehicle approaches node C, it may select a recommended action from the ‘global’ journey policy that comprises a recommended speed action and a next probabilistic state that identifies node E, an expected value of time metric for arrival at node E and an expected value of efficiency metric for arrival at node E. Determining and using the ‘local’ journey policy for the interconnecting edge between node C and node E may help to keep the vehicle on track for achieving the expected value of time metric for arrival at node E and the expected value of efficiency metric for arrival at node E. For example, if progress is relatively slow along the first half of the interconnecting edge between node C and node E, use of the ‘local’ journey policy may result in a faster speed action being recommended for the second half of the ‘local’ journey, thereby compensating for the initially slow progress.

Furthermore, where interconnecting edge amalgamation was used for determination of the ‘global’ journey policy, determining and using a ‘local’ journey policy may help to repair some of the certainty and resolution that was lost. Because the local policy considers only a part (for example, one interconnecting edge) of the ‘global’ journey, the computational overheads of determining the ‘local’ journey policy may be small compared with that of the ‘global’ journey policy. Thus, computational efficiency may be achieved for the ‘global’ journey policy by using interconnecting edge amalgamation without suffering an overall significant loss in certainty and resolution because that resolution and certainty may be reintroduced at the ‘local’ journey level, where computational overheads are relatively low.

Furthermore, the ‘local’ journey policy may utilise more up-to-date information than that used for the determination of the ‘global’ journey policy. For example, traffic data and/or weather data used for the determination of the ‘global’ journey policy may offer a prediction of traffic and/or weather conditions for a stretch of road late on in the journey. For a long ‘global’ journey, that stretch of road may be many hours into the journey, such that the prediction relates to conditions that may be present a number of hours in the future. By determining a ‘local’ journey policy, more up-to-date weather data and/or traffic data (for example, real-time data) may be used for that stretch of road, such that the timeliness and accuracy of the data may be increased. Thus, if the actual weather and/or traffic conditions are quite different to those that were predicted at the time of ‘global’ journey policy determination, the ‘local’ journey policy may compensate for the changes to improve the chances that the destination objectives are still achieved.

The skilled person will appreciate that a number of modifications or alternatives may be made to the specific aspects described above.

For example, in the above, a ‘global’ journey policy is determined and used and optionally a ‘local’ journey policy may also be determined and used. Whilst using both the ‘global’ and ‘local’ journey policies may be preferable, in an alternative, only the ‘local’ journey policy may be used. For example, an existing navigation API may be used to set a route for a ‘global’ journey. That route may have an estimated arrival time at the destination of the ‘global’ journey, which is based on average speeds for each interconnecting edge on the ‘global’ journey. ‘Local’ journey policies may be determined and used as the vehicle progresses along the ‘global’ journey, with the end objective of each ‘local’ journey being the arrival time at the end of the ‘local’ journey, determined based on the expected average speed on the road(s) of the ‘local’ journey. Utilising ‘local’ journey policies on routes offered by existing navigation systems may provide benefits in helping to keep the vehicle on target for the estimated arrival time, by guiding the vehicle's speed to help compensate for any periods of above average or below average speed. Thus, the user may be more confident of arriving at the destination of the ‘global’ journey at the estimated arrival time.

In the above aspects, the route guidance module 110 carries out the determinations of the journey definition, the ‘global’ journey and the ‘local’ journey policy. However, any one or more of these may be determined elsewhere, for example by the infrastructure server 128. In one implementation, the ‘global’ policy is determined using cloud computing, since determination of the ‘global’ policy is likely to be very computationally intensive (particularly for long ‘global’ journeys). In this way, the substantial computing power offered by ‘the cloud’ may be utilised. If the ‘global’ and/or ‘local’ journey policy is determined by an entity other than the route guidance module 110, the route guidance module 110 may obtain the ‘global’ and/or ‘local’ policy using interface 140. For example, it may send the journey definition to the infrastructure server 128 or ‘the cloud’ with a request for the ‘global’ journey policy and then receive the determined ‘global’ journey policy (a ‘pull’ request), or it may simply receive it from the infrastructure server 128 or ‘the cloud’ without requesting it (a ‘push’ communication). Optionally, whilst the ‘global’ journey policy is being determined by the infrastructure sever 128 or ‘the cloud’, the journey may commence using basic navigation instructions (for example, from the journey definition), and once the ‘global’ journey policy has been received from the cloud, it may be used to provide guidance for the rest of the ‘global’ journey. Additionally, or alternatively, the route guidance module 110 may obtain the journey definition and/or ‘local’ journey policy in the same way. In the above aspects, the user sets the destination location, journey objectives and the destination objectives using the route guidance module 110. However, in an alternative, these may be set in other ways. For example, a user may utilise a computer terminal to set any one or more of these items at the route guidance server 126 (such as a driver wishing to plan a ‘global’ journey on their desktop computer in advance, or a taxi dispatcher wishing to plan a ‘global’ journey for a taxi, wherein the ‘global’ journey policy may then be transmitted to a route guidance module 110 in that taxi, etc). The route guidance server 126 may communicate those set values to the route guidance module 110 via the interface 140 for the determination of the journey definition, or it may determine the journey definition and communicate that to the route guidance module 110, or it may determine the journey definition and the ‘global’ journey policy (or have ‘the cloud’ determine the ‘global’ journey policy) and then communicate the ‘global’ journey policy to the route guidance module 110.

In the above aspects, journey objectives and destination objectives are used. However, in an alternative, only one of journey objectives or destination objectives may be used. For example, journey objectives may not be utilised at all, with comfort and attitude to speed limits playing no part in the determination of ‘global’ or ‘local’ policies.

In the above, the end objective comprises a punctuality objective and an efficiency objective. However, in an alternative, it may comprise only a punctuality objective, or only an efficiency metric. For example, in an alternative implementation, it may be possible to set only a punctuality objective, in which case the processes described above may be configured to achieve the punctuality objective (and journey objective, if set) without any consideration to efficiency.

The term ‘vehicle’ used throughout this application encompasses any machinery that is capable of transporting people and/or goods, for example a car, automobile, lorry, truck, van, bus, bicycle, etc. Whilst the disclosure has been described particularly in the context of road-going vehicles, it will be appreciated that it may be applied to non-road going vehicles, for example aeroplanes, ships, trains, etc. For non-road-going vehicles, rather than determining the directed graph based on an unconstrained road network, any suitable network may be used, for example the constrained railway network for a train, or unconstrained shipping lanes and navigation way-points for a ship, or unconstrained flight corridors and patterns for an aeroplane. Furthermore, whilst the disclosure has been described particularly in the context of guidance for a journey taken in a vehicle, it will be appreciated that it may be applied to non-vehicle journeys, for example pedestrians (or runners) making a journey on a road network, or in the wilderness where the directed graph may be determined based on any suitable constraint network such as walking trails, or navigation waypoints, etc.

1. An electronic device for determining a journey guidance policy for use in guidance on a journey from a first location to a second location, the electronic device being configured to:
obtain an end objective indicative of an objective to be achieved at the end of the journey at the second location;
determine a plurality of probabilistic states for the journey, each probabilistic state comprising:
a state location, indicative of a geographical location; and
a progress metric; and
determine, based at least in part on the plurality of probabilistic states and the end objective, the journey guidance policy, the journey guidance policy comprising the plurality of probabilistic states and a recommended action corresponding to each of the plurality of probabilistic states, wherein each recommended action comprises a speed action and a navigation action.

2. The electronic device of claim 1, further configured to determine the plurality of probabilistic states as a sequential decision problem comprising the plurality of probabilistic states, and to determine the journey guidance policy by solving the sequential decision problem.

3. The electronic device of claim 2, wherein the sequential decision problem is a Markov Decision Process, a semi-Markov Decision Process or an Interval Markov Decision Process.

4. (canceled)

5. The electronic device of claim 2, further configured to solve the sequential decision problem using at least value iteration and/or policy iteration; and optionally using a sampling technique.

6. (canceled)

7. The electronic device of claim 1, further configured to perform an elimination process by:
before determining the journey guidance policy, selecting a probabilistic state from the plurality of probabilistic states;
assessing whether the end objective can be achieved from the selected probabilistic state based on the state location and a value of the progress metric in the selected probabilistic state; and
if the end objective cannot be achieved from the selected probabilistic state, eliminating the selected probabilistic state from the plurality of probabilistic states.

8. The electronic device of claim 7, wherein the assessment of whether the end objective can be achieved is performed using a heuristic function.

9. (canceled)

10. (canceled)

11. The electronic device of claim 1, further configured to:
obtain weather data and/or traffic data; and
determine each of the plurality of probabilistic states based at least in part on at least part on the weather data and/or traffic data.

12. (canceled)

13. The electronic device of claim 1, further configured to:
obtain a directed graph of routing options comprising a plurality of nodes and a plurality of interconnecting edges, wherein each of the plurality of interconnecting edges are representative of at least part of at least one road in a road network, and wherein the directed graph of routing options defines one or more routes from the first location to the second location, wherein
the state location of each probabilistic state is indicative of the geographic location of any one of the plurality nodes in the directed graph of routing options.

14. The electronic device of claim 13, wherein each of the interconnecting edges has an associated attribute and the electronic device is further configured to:
determine each of the plurality of probabilistic states based at least in part on the attributes associated with the plurality of interconnecting edges, wherein the associated attribute comprises at least one of:
a travelling distance for the part of the journey represented by the associated interconnecting edge;
a speed limit for the part of the journey represented by the associated interconnecting edge;
a gradient for the part of the journey represented by the associated interconnecting edge;
a type of road represented by the associated interconnecting edge;
an indication of a road surface of the road represented by the associated interconnecting edge; and
an indication of a curvature of the road represented by the associated interconnecting edge.

15. (canceled)

16. (canceled)

17. (canceled)

18. The electronic device of claim 14, further configured to obtain the directed graph of routing options by:
obtaining mapping data comprising a directed graph;
creating a coarse directed graph by replacing a segment of the directed graph of the mapping data with a coarse segment; and
determining the directed graph of routing options based on the coarse directed graph; wherein
the segment comprises two or more initial interconnecting edges of the plurality of initial interconnecting edges; and wherein
the coarse segment comprises at least one interconnecting edge, and wherein
the number of interconnecting edges in the coarse segment is less than the number of initial interconnecting edges in the segment.

19. The electronic device of claim 18, wherein each of the initial interconnecting edges in the directed graph of the mapping data has an associated edge attribute, and wherein creating the coarse directed graph comprises:
associating a coarse attribute that is based at least in part on at least some of the attributes associated with the interconnecting edges in the segment.

20. The electronic device of claim 1, wherein the journey is a ‘global’ journey, the first location is a start location for the ‘global’ journey, the second location is a ‘destination’ location for the global journey and the end objective is a destination objective.

21. The electronic device of claim 20, further configured to obtain the directed graph of routing options by:
obtaining an initial directed graph of routing options comprising a plurality of initial nodes and a plurality of initial interconnecting edges that together define one or more routes from the first location to the second location; and
creating the directed graph of routing options by replacing a segment of the initial directed graph with a coarse segment, wherein
the segment comprises two or more initial interconnecting edges of the plurality of initial interconnecting edges; and wherein
the coarse segment comprises at least one interconnecting edge, and wherein
the number of interconnecting edges in the coarse segment is less than the number of initial interconnecting edges in the segment.

22. The electronic device of claim 21, wherein each of the initial interconnecting edges in the initial directed graph of routing options has an associated initial edge attribute; and wherein creating the directed graph of routing options further comprises:
for each of the interconnecting edges in the coarse segment, associating an attribute that is based at least in part on at least some of the initial edge attributes associated with the initial interconnecting edges in the segment.

23. (canceled)

24. The electronic device of claim 1, wherein the journey is a ‘local’ journey that is part of a ‘global’ journey from a start location to a destination location, and wherein at least one of the first location and the second location are intermediate locations on the ‘global’ journey.

25. The electronic device of claim 24, further configured to obtain the directed graph of routing options by:
obtaining an initial directed graph of routing options comprising at least one initial interconnecting edge, the initial directed graph of routing options defining one or more routes from the first location to the second location; and
creating the directed graph of routing options by replacing a segment of the initial directed graph with a fine segment, wherein
the segment comprises one or more of the at least one initial interconnecting edge; and wherein
the fine segment comprises two or more interconnecting edges, and wherein
the number of interconnecting edges in the fine segment is greater than the number of initial interconnecting edges in the segment.

26. The electronic device of claim 25, wherein creating the directed graph of routing options further comprises:
associating an attribute with each of the interconnecting edges in the fine segment.

27. The electronic device of claim 1, further configured to:
obtain a journey objective; and
determine the plurality of probabilistic states based at least in part on the journey objective; wherein the journey objective comprises at least one of:
(i) a comfort objective;
(ii) a legality objective.

28. (canceled)

29. The electronic device of claim 1, wherein the end objective comprises at least one of:
(i) a punctuality objective; and
(ii) an efficiency objective.

30. The electronic device of claim 1, wherein two or more probabilistic states in the plurality of probabilistic states comprise state locations indicative of the same geographical location, but different values of progress metric.

31. The electronic device of claim 30, wherein the number of probabilistic states in the plurality of probabilistic states that comprise state locations indicative of the same geographical location, but different values of progress metric, depends on the distance of the geographical location into the journey and/or the complexity of the navigation environment at and/or immediately preceding, the geographical location.

32. The electronic device of claim 1, wherein the journey is on an unconstrained transportation network.

33. The electronic device of claim 1, wherein the electronic device is one of: a mobile electronic device; an electronic device for fitting in a vehicle; and a server, or a plurality of interconnected servers.

34. (canceled)

35. (canceled)

36. (canceled)

37. A route guidance module for use in guidance on a journey from a first location to a second location, the route guidance module being configured to:
obtain a journey guidance policy comprising a plurality of probabilistic states for the journey a recommended action corresponding to each of the plurality of probabilistic states;
obtain a current journey state;
select, based on the current journey state and the plurality of probabilistic states in the journey guidance policy, a recommended action from the journey guidance policy; and
output action data based on the selected recommended action, wherein the action data is for use in guiding a next action on the journey and comprises a speed action and a navigation action.

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. (canceled)

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. (canceled)

97. (canceled)

98. (canceled)

99. (canceled)

100. (canceled)

101. (canceled)

102. (canceled)

103. (canceled)

104. (canceled)

105. (canceled)

106. (canceled)

107. (canceled)

108. (canceled)

109. (canceled)

110. (canceled)

111. (canceled)

112. (canceled)

113. (canceled)

114. (canceled)

115. (canceled)

116. (canceled)

117. (canceled)

118. (canceled)

119. (canceled)

120. (canceled)

121. (canceled)

122. (canceled)

123. A route guidance system for providing guidance on a journey from a first location to a second location, the route guidance system comprising:
an electronic device configured to:
obtain an end objective indicative of an objective to be achieved at the end of the journey at the second location;
determine a plurality of probabilistic states for the journey, each probabilistic state comprising:
a state location, indicative of a geographical location; and
a progress metric; and
determine, based at least in part on the plurality of probabilistic states and the end objective, the journey guidance policy, the journey guidance policy comprising the plurality of probabilistic states and a recommended action corresponding to each of the plurality of probabilistic states, wherein each recommended action comprises a speed action and a navigation action; and
a route guidance module configured to:
obtain the journey guidance policy from the electronic device;
obtain a current journey state;
select, based on the current journey state and the plurality of probabilistic states in the journey guidance policy, a recommended action from the journey guidance policy; and
output action data based on the selected recommended action, wherein the action data is for use in guiding a next action on the journey and comprises a speed action and a navigation action.
